(19) United States
(12) Patent Application Publication
(10) Pub. No.: US 2026/0307437 A1
(43) Pub. Date: Oct. 8, 2026

(54) SWING AWAY HITCH ADAPTER

(71) Applicant: Thule Sweden AB, Hillerstorp (SE)

(72) Inventors: Daniel Klas KARLSSON, Hok (SE); Fredrik LARSSON, Vaggeryd (SE); Filip WÄRNELÖV, Värnamo (SE); Anders TÖRELAND, Anderstorp (SE)

(21) Appl. No.: 19/633,304

(22) Filed: Mar. 30, 2026

Related U.S. Application Data
(60) Provisional application No. 63/783,626, filed on Apr. 4, 2025.

(51) Int. Cl. B60D 1/07

(52) U.S. Cl. CPC B60D 1/075

(57) ABSTRACT

The present disclosure is directed to a hitch adapter. In some embodiments, the hitch adapter includes a first arm extending parallel relative to a first plane in a closed configuration and a second arm pivotably coupled to the first arm. In some embodiments, the hitch adapter includes a receiver disposed at an end of the second arm and a stinger coupled to and extending orthogonally from the first arm, extending orthogonally relative to the first plane, and configured to couple to a vehicle hitch receiver. In some embodiments, a proximal end of the stinger is configured to engage the vehicle hitch receiver. In some embodiments, the first arm and the second arm form an acute angle in the first plane in the closed configuration. In some embodiments, a length of the first arm is approximately the same as a length of the second arm.

### CROSS REFERENCE TO RELATED APPLICATIONS

This application claims the benefit of and priority to U.S. Provisional Appl. No. 63/783,626, filed Apr. 4, 2025, which is incorporated herein in its entirety by reference.

### FIELD

The present disclosures relates to a vehicle hitch adapter. In particular, the present disclosures relates to a swing away hitch adapter.

### BACKGROUND

Vehicle hitch tubes are configured to receive, for example, a load carrier (e.g., bicycle rack) so users can transport equipment (e.g., bicycles). Some load carriers (e.g., hitch mounted load carriers), however, can interfere with access to a vehicle's rear compartment. To access the vehicle's rear compartment, users may need to remove the load carrier, which may be inconvenient and time-consuming.

### SUMMARY

The present disclosure is directed to a hitch adapter and/or a hitch mounted load carrier system. In some embodiments, the hitch adapter includes a first arm extending parallel relative to a first plane in a closed configuration and a second arm pivotably coupled to the first arm. In some embodiments, the hitch adapter includes a receiver disposed at an end of the second arm and a stinger coupled to and extending orthogonally from the first arm, extending orthogonally relative to the first plane, and configured to couple to a vehicle hitch receiver. In some embodiments, a proximal end of the stinger is configured to engage the vehicle hitch receiver. In some embodiments, the first arm and the second arm form an acute angle in the first plane in the closed configuration. In some embodiments, a length of the first arm is approximately the same as a length of the second arm.

In some embodiments, the first arm includes a first segment and a second segment, the first segment is parallel to the second arm in the first plane, and the second segment forms an acute angle with the second arm in the first plane. In some embodiments, the first arm includes a third segment disposed parallel to the first segment. In some embodiments, the first segment forms a first end of the first arm and the third segment forms a second end of the first arm. In some embodiments, the third segment is disposed below the first segment. In some embodiments, the first segment has a first length and the second segment has a second length, and the second length is greater than the first length. In some embodiments, a longitudinal axis of the receiver is collinear with a longitudinal axis of the stinger in the closed configuration.

In some embodiments, the hitch adapter of the present disclosure includes a brace disposed on an upper surface of the stinger and disposed proximate a distal end of the stinger. In some embodiments, the receiver is configured to abut the brace in the closed configuration. In some embodiments, the hitch adapter includes a housing disposed at the second end of the first arm. In some embodiments, the housing is configured to receive a portion of the receiver in the closed configuration. In some embodiments, the hitch adapter includes an actuator configured to unlock the receiver from the housing, and configured to lock the receiver inside the housing. In some embodiments, the actuator is configured to expand a linkage. In some embodiments, at least a portion of the linkage is configured to contact a floor of the receiver in the closed configuration.

In some embodiments, the hitch mounted load carrier system of the present disclosure includes a load carrier and a hitch adapter. In some embodiments, the hitch adapter includes a first arm, a second arm pivotably coupled to the first arm at a rotation joint, and configured to pivot between a closed configuration and an open configuration. In some embodiments, the hitch adapter includes a receiver disposed on the second arm. In some embodiments, the receiver includes a first portion and a second portion. In some embodiments, the hitch adapter includes a stinger coupled to and extending orthogonally from the first arm, and a brace disposed on the stinger. In some embodiments, the brace is configured to apply a normal force to the second portion of the receiver in the closed configuration.

In some embodiments, the hitch mounted load carrier system includes a catch protruding from the brace, and an aperture disposed in the receiver, wherein the aperture is configured to receive the catch in the closed configuration. In some embodiments, the catch is configured to restrict vertical movement of the second arm in the closed configuration. In some embodiments, the brace includes a ramp configured to bias the receiver into vertical alignment with a housing. In some embodiments, the receiver is disposed at an incline relative to the stinger in the closed configuration.

In some embodiments, the hitch mounted load carrier system includes a housing disposed on the first arm, wherein the housing includes a key configured to lock the second arm in the closed configuration. In some embodiments, the receiver comprises a latch disposed on the first portion of the receiver and configured to receive the key in the closed configuration. In some embodiments, the key comprises a first portion and a second portion, the latch comprises a first slot configured to receive the first portion of the key, and the latch comprises a second slot configured to receive the second portion of the key.

In some embodiments, the hitch mounted load carrier system includes a locking pin disposed proximate the rotation joint. In some embodiments, the locking pin is configured to restrict rotation of the second arm in the open configuration.

### BRIEF DESCRIPTION OF THE DRAWINGS/FIGURES

FIG. 1 is a rear perspective view of a hitch adapter in a closed configuration according to an embodiment;

FIG. 2 is a top view of a hitch adapter in a closed configuration according to an embodiment;

FIG. 3 is a top perspective view of a hitch adapter in an open configuration according to an embodiment;

FIG. 4 is a side view of a hitch adapter in an open configuration according to an embodiment;

FIG. 5 is a front view of a hitch adapter in a closed configuration according to an embodiment;

FIG. 6 is a rear view of a hitch adapter in a closed configuration according to an embodiment;

FIG. 7A is a partial top view of a hitch adapter in a closed configuration according to an embodiment;

FIG. 7B is a cross sectional side perspective view of a hitch adapter in a closed configuration according to an embodiment;

FIG. 7C is a side cross sectional view of a hitch adapter in a closed configuration according to an embodiment;

FIG. 7D is a is a side view of a hitch adapter in a closed configuration according to an embodiment;

FIG. 7E is a rear view of a hitch adapter in a closed configuration according to an embodiment;

FIG. 8A is a perspective cross sectional view of a hitch adapter in a locked configuration according to an embodiment;

FIG. 8B is a perspective cross sectional view of a hitch adapter in an unlocked configuration according to an embodiment;

FIG. 9 is a partial view of a lock for a hitch adapter according to an embodiment;

FIG. 10 is a partial view of a receiver for a hitch adapter according to an embodiment;

FIG. 11A is a partial rear cross sectional view of a hitch adapter in a locked configuration according to an embodiment;

FIG. 11B is a partial rear cross sectional view of a hitch adapter in an unlocked configuration according to an embodiment;

FIG. 11C is a partial perspective view of a hitch adapter in a locked configuration according to an embodiment;

FIG. 11D is a partial cross-sectional perspective view of a hitch adapter in a locked configuration according to an embodiment;

FIG. 11E is a partial cross-sectional perspective view of a hitch adapter in a locked configuration according to an embodiment;

FIG. 12A is a partial perspective view of a hitch adapter in a locked configuration according to an embodiment;

FIG. 12B is a partial perspective view of a hitch adapter in an unlocked configuration according to an embodiment;

FIG. 13 is a side view of a hitch adapter according to an embodiment;

FIG. 14 is a partial perspective view of a hitch adapter according to an embodiment;

FIG. 15 is a partial side view of a hitch adapter according to an embodiment;

FIG. 16 is a partial side view of a hitch adapter according to an embodiment;

FIG. 17 is a perspective view of a hitch adapter in a closed configuration according to an embodiment;

FIG. 18 is a side view of a hitch adapter in a closed configuration according to an embodiment;

FIG. 19 is a is side cross sectional view of a hitch adapter in a closed configuration according to an embodiment;

FIG. 20 is a partial perspective view of a hitch adapter in a closed configuration according to an embodiment;

FIG. 21 is a partial exploded view of a hitch adapter in a closed configuration according to an embodiment;

FIG. 22 is a top view of a hitch adapter in an open configuration according to an embodiment;

FIG. 23 is a partial perspective view of a hitch adapter in an open configuration according to an embodiment;

FIG. 24A is a partial perspective view of a hitch adapter in a closed configuration according to an embodiment;

FIG. 24B is a partial perspective view of a hitch adapter in an open configuration according to an embodiment

FIG. 25A is a partial perspective view of a hitch adapter in a closed configuration according to an embodiment;

FIG. 25B is a partial perspective view of a hitch adapter in an open configuration according to an embodiment;

FIG. 26 is a partial transparent side view of a hitch adapter in a closed configuration according to an embodiment;

FIG. 27 is a cross sectional perspective view of a rotation joint for a hitch adapter in a closed configuration according to an embodiment;

FIG. 28A is a cross sectional perspective view of a rotation joint for a hitch adapter in an open configuration according to an embodiment;

FIG. 28B is a cross sectional perspective view of a rotation joint for a hitch adapter in an open configuration according to an embodiment;

FIG. 29A is a front perspective view of a rotation joint for a hitch adapter in a closed configuration according to an embodiment;

FIG. 29B is a front perspective view of a rotation joint for a hitch adapter in an open configuration according to an embodiment;

FIG. 29C is a top cross sectional view of a rotation joint for a hitch adapter in a closed configuration according to an embodiment;

FIG. 29D is a partial perspective view of a rotation joint for a hitch adapter in a closed configuration according to an embodiment;

FIG. 29E is a partial perspective view of a rotation joint for a hitch adapter in an open configuration according to an embodiment;

FIG. 30 is a perspective view of a hitch adapter according to an embodiment;

FIG. 31 is a front perspective view of a rotation joint for a hitch adapter in a closed configuration according to an embodiment;

FIG. 32 is a front perspective view of a hitch adapter in a closed configuration according to an embodiment;

FIG. 33A is a perspective view of a hitch adapter in an open configuration according to an embodiment; and

FIG. 33B is a partial cross-sectional perspective view of a hitch adapter of in a closed configuration according to an embodiment.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., ±1%, ±2%, ±5%, ±10%, or ±15% of the value). As used herein, the term “between” indicates an inclusive range.

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

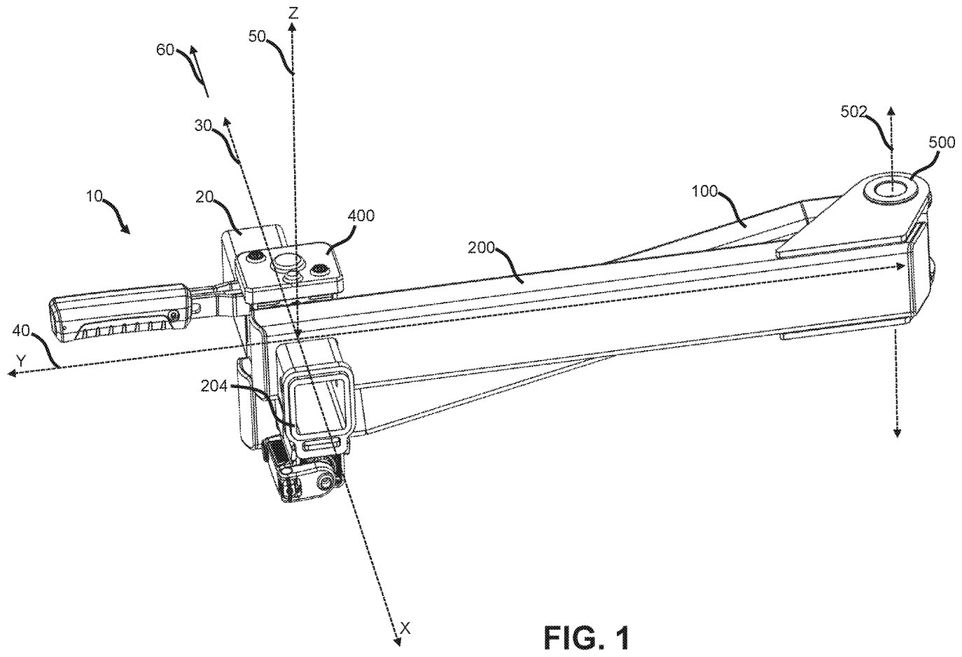

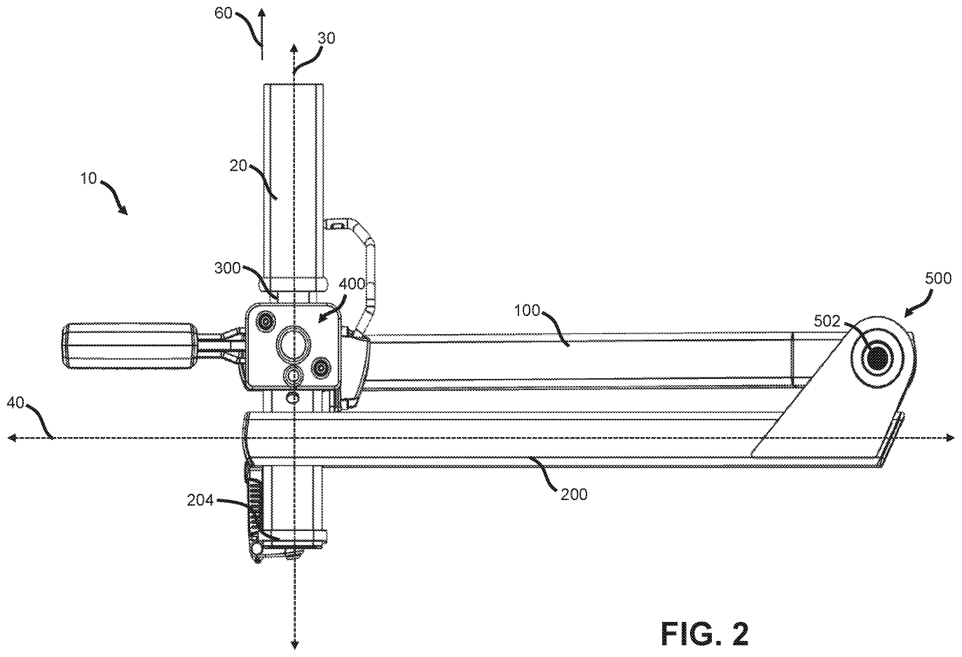

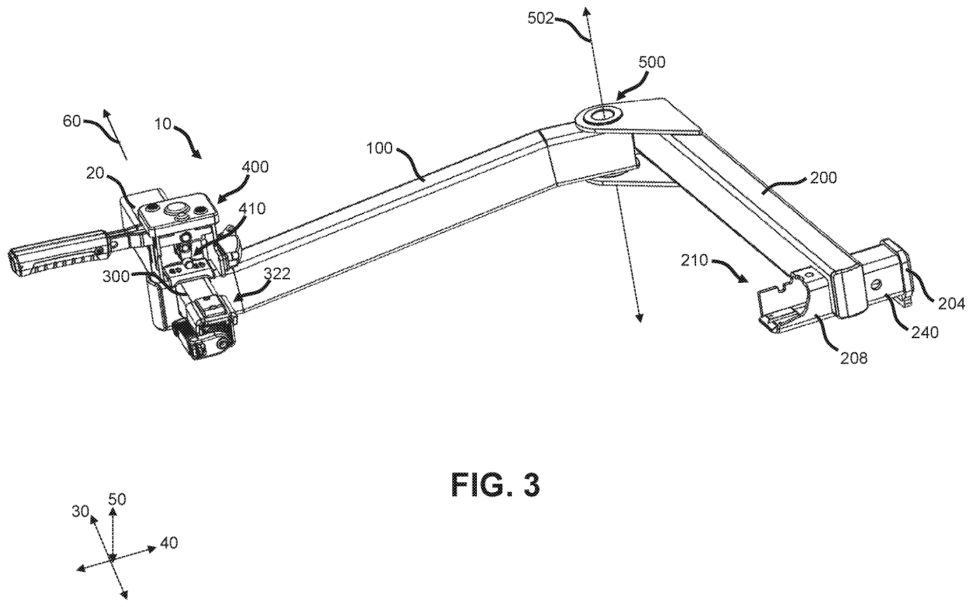

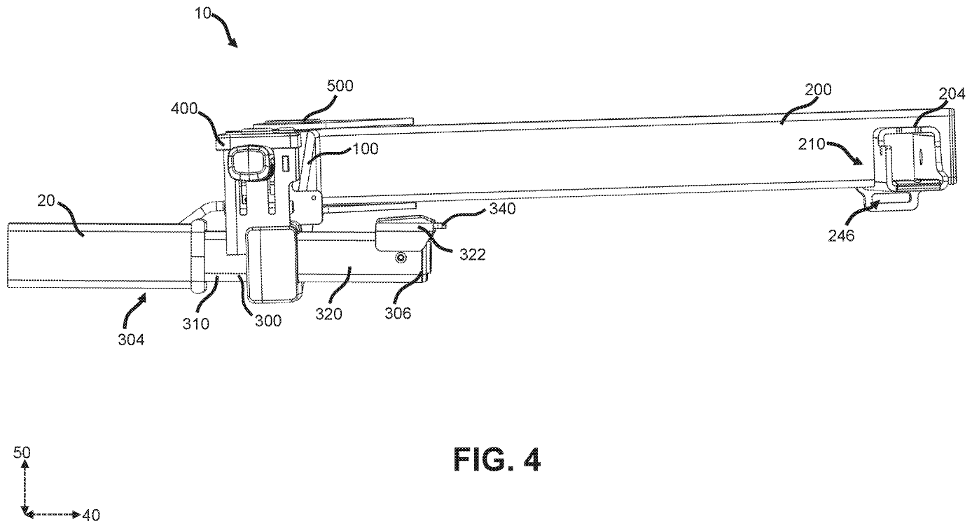

Referring to FIGS. 1-4, the present disclosure includes a hitch adapter 10 configured to engage a vehicle hitch receiver 20. In some embodiments, hitch adapter 10 includes a stinger 300 coupled to first arm 100 and configured to engage vehicle hitch receiver 20. In some embodiments, as shown for example in FIG. 4, stinger 300 includes a first portion 310 including a proximal end 304 and a second portion 320 including a distal end 306. Hitch adapter 10 can be disposed in a closed configuration, as shown for example in FIGS. 1-2, and an open configuration, as shown for example in FIGS. 3-4. In some embodiments, hitch adapter 10 includes a first arm 100 and a second arm 200 pivotably coupled to first arm 100, for example, via a rotation joint 500. In some embodiments, second arm 200 is configured to lock with a housing 400 disposed on first arm 100.

In some embodiments, first arm 100 is a static arm and second arm 200 is a pivot, or swing, arm. In some embodiments, second arm 200 is configured to pivot about a rotation axis 502 extending through rotation joint 500. In some embodiments, hitch adapter 10 includes a receiver 204 configured to receive a load support, for example, a rack that supports one or more bicycles. In some embodiments, receiver 204 is disposed on second arm 200 so that, for example, a user can swing open second arm 200 to access a rear compartment of the vehicle while a bicycle rack is attached to hitch adapter 10. In some embodiments, as shown for example in FIG. 3, receiver 204 includes a first portion 208 and a second portion 240, where first portion 208 is configured to lock with housing 400, for example inside housing 400, in the closed configuration.

As shown for example in FIG. 1, an X-axis 30 extends parallel to a longitudinal axis of stinger 300 and in a vehicle direction 60, a Y-axis 40 extends parallel to a longitudinal axis of second arm 200 in the closed configuration and orthogonal to vehicle direction 60, and a Z-axis 50 extends vertically relative to, for example, stinger 300. As used herein, the term “front” (e.g., front view) indicates a view of, for example, hitch adapter 10, opposite vehicle direction 60. As user herein, the term “rear” (e.g., rear view) indicates, a view of, for example hitch adapter 10 in vehicle direction 60. In some embodiments, as shown for example in FIGS. 1-2, first arm 100 and second arm 200 are parallel to the YZ plane in the closed configuration.

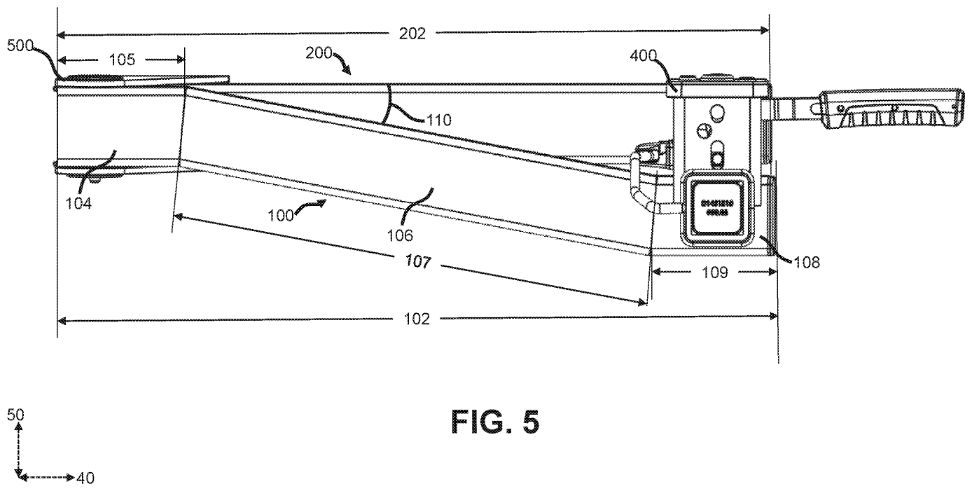

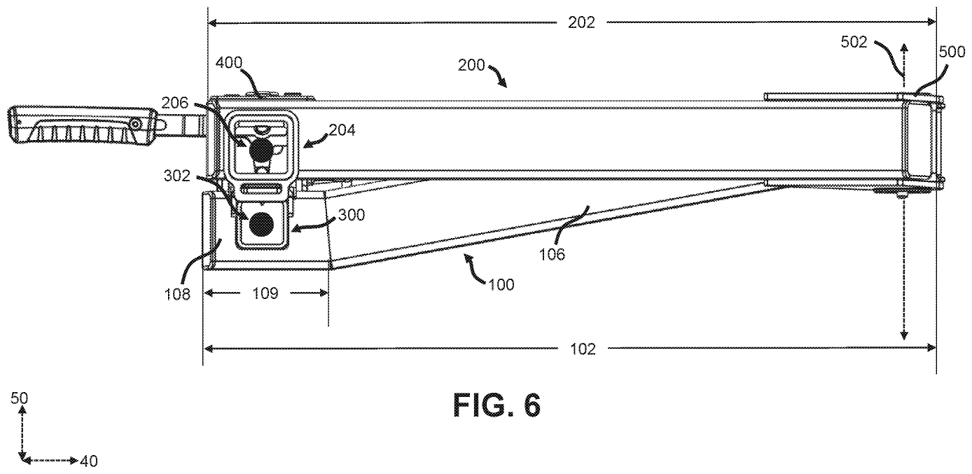

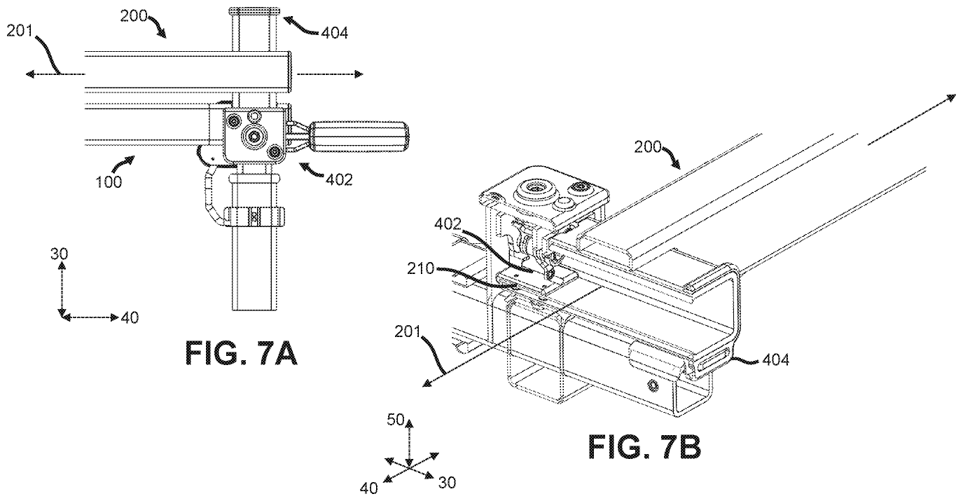

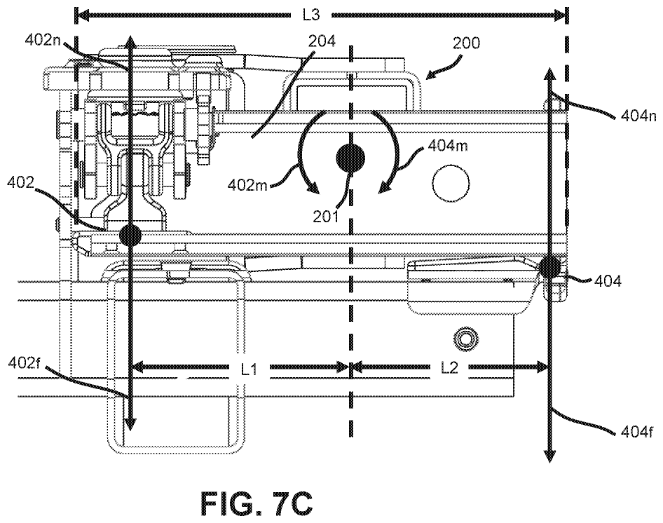

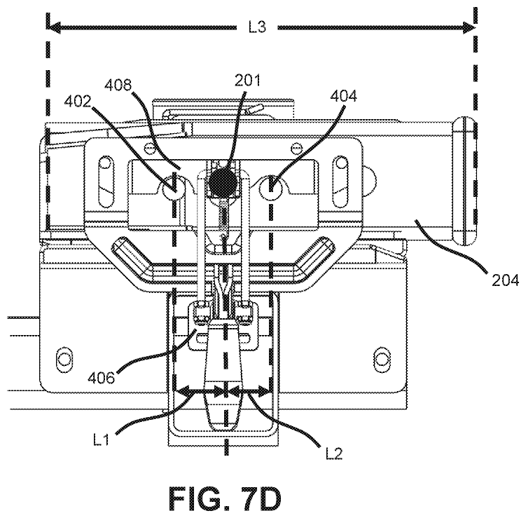

In some embodiments, as shown for example in FIG. 1 and discussed in detail below (e.g., relative to FIGS. 5-6), at least a portion of first arm 100 forms an angle 110 with second arm 200 in a plane parallel to the YZ plane in the closed configuration. In some embodiments, as discussed in detail below (e.g., relative to FIGS. 7A-13) second arm 200 is configured to lock with housing 400 in the closed configuration, and second arm 200 is configured to be decoupled from housing 400 and swing to the open configuration. In some embodiments, as shown for example in FIG. 3 and discussed in detail below (e.g., relative to FIGS. 7A-13) second arm 200 includes a receiver latch 210 configured to engage a key 410 disposed in housing 400 to lock first arm 100 and second arm 200 in the closed configuration.

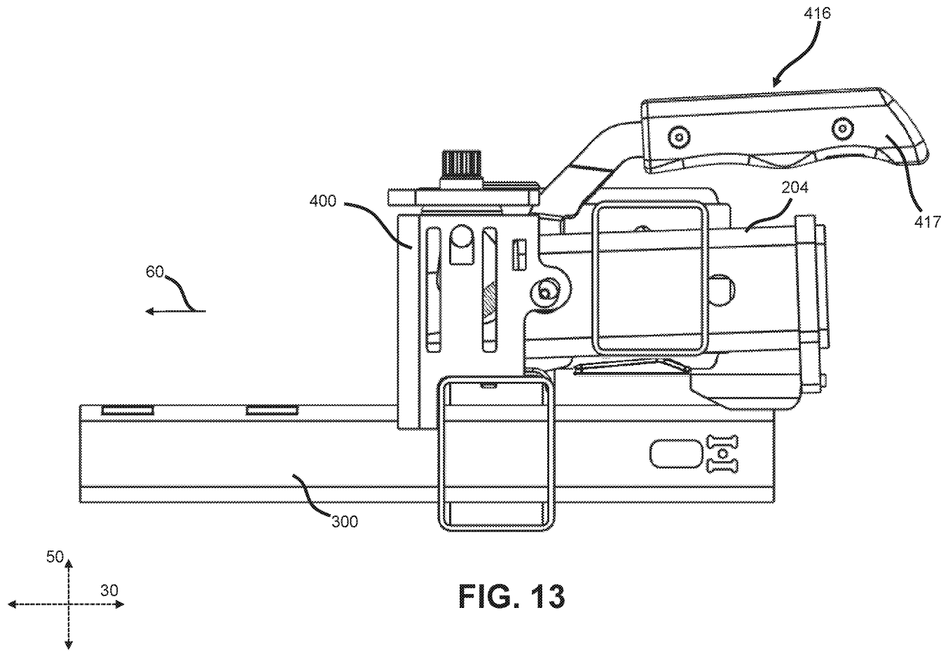

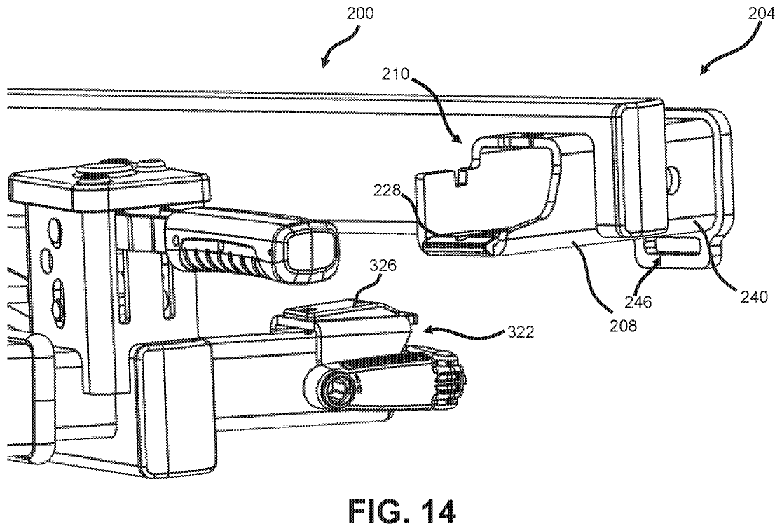

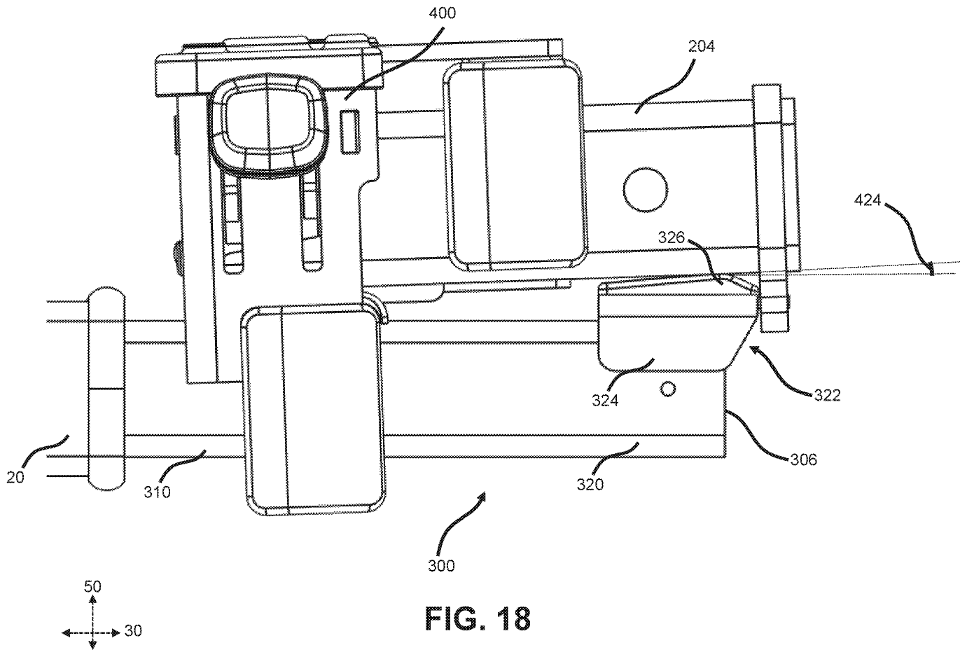

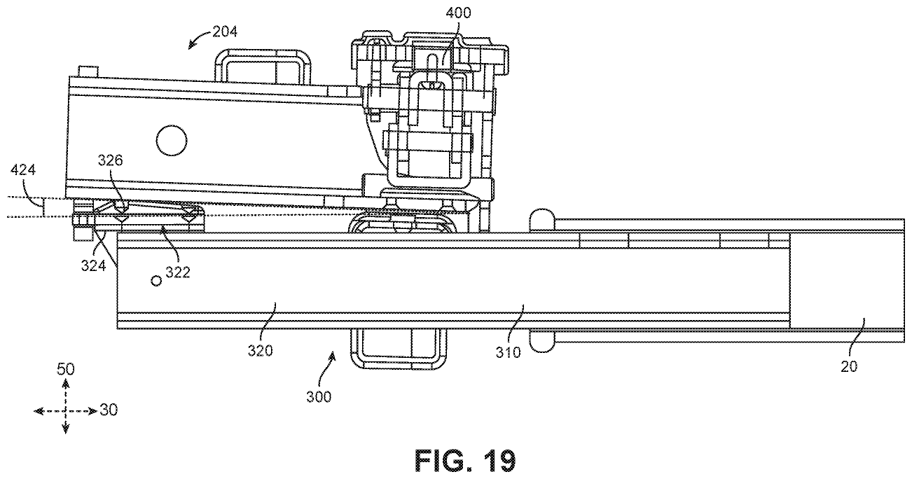

In some embodiments, as shown for example in FIG. 4 and discussed in detail below (e.g., relative to FIGS. 14-17), hitch adapter 10 includes a brace 322 disposed on stinger 300 and configured to guide second arm 200 into housing 400 when transitioning from the open configuration to the closed configuration. In some embodiments, as shown for example in FIG. 4 and discussed in detail below (e.g., relative to FIGS. 13-16), receiver 204 includes an aperture 246 configured to receive a catch 340 disposed on brace 322 in the closed configuration. In some embodiments, as shown for example in FIG. 1 and discussed in detail below (e.g., relative to FIGS. 18-19) brace 322 is configured to support at least a portion of receiver 204 in the closed configuration.

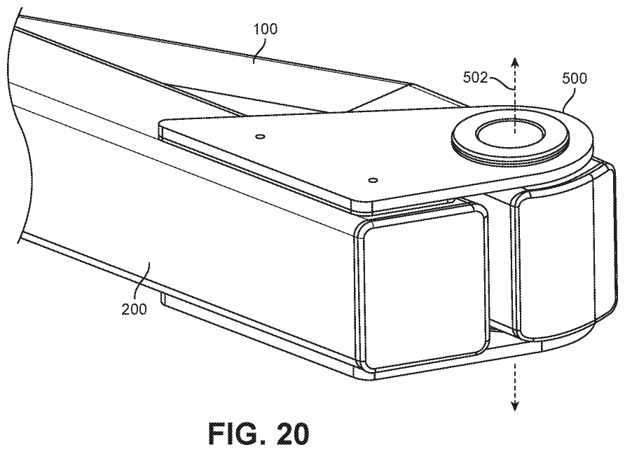

In some embodiments, as shown for example in FIGS. 1-4 and discussed in detail below (e.g., relative to FIGS. 20-30), rotation joint 500 is configured to allow second arm 200 to rotate from the closed configuration to the open configuration while mitigating vibrations and unintentional rotation in the closed configuration. As discussed below, the embodiments disclosed herein mitigate vibrations and movement of hitch adapter 10 during use (e.g., while driving) to improve durability and reduce noise.

In some embodiments, as shown for example in FIG. 5, first arm 100 and second arm 200 form a decline angle 110 in a plane parallel to the YZ plane. An angled relationship between first arm 100 and second arm 200 can better absorb forces transmitted in a combination of Y-Axis 40 and Z-axis 50 relative to designs including arms that are parallel in the YZ plane. Orienting second arm 200 normal to forces having a component in Y-Axis 40 and Z-axis can better absorb the variety of forces encountered during use (e.g., driving). Absorbing forces transmitted in multiple axes can mitigate vibration and movement of hitch adapter 10 when, for example, hitch adapter 10 is used to transport a load (e.g., bicycle rack) on an uneven surface (e.g., trails, rough terrain).

In some embodiments, as shown for example in FIG. 5, first arm 100 includes a first segment 104 with a first segment length 105, an angled segment 106 with an angled segment length 107, and an end segment 108 with an end segment length 109. In some embodiments, as shown for example in FIG. 5, first segment 104 and end segment 108 are parallel with second arm 200 in the YZ plane, and angled segment 106 forms decline angle 110 with second arm 200 in the YZ plane. In some embodiments, angled segment length 107 is greater than first segment length 105 and end segment length 109. In some embodiments, angled segment length 107 is greater than the combined length of the first segment length 105 and the end segment length 109. In some embodiments, angled segment length 107 is more than 25% greater than the combined first segment length 105 and end segment length 109. In some embodiments angled segment length 107 is more than 50% greater, more than 75% greater, or more than 100% greater (e.g., 2×) than the combined first segment length 105 and end segment length 109. A greater angled segment length 107 mitigates vibrations and movement of hitch adapter 10 because a greater portion of first arm 100 is oriented normal to forces having components in, for example, Y-axis 40 and Z-axis 50.

In some embodiments, first arm 100 includes first segment 104 and angled segment 106 (e.g., no end segment), and angled segment 106 is disposed at decline angle 110 relative to second arm 200.

In some embodiments, first arm 100 includes angled segment 106 that extends from and/or through rotation axis 502 to first arm second end (e.g., no first segment or end segment), and is disposed at decline angle 110 relative to second arm 200. In some embodiments, for example, rotation axis 502 extends through the vertex of decline angle 110. As discussed above, increasing angled segment length 107 mitigates vibrations and movement of hitch adapter 10 by absorbing a greater magnitude of forces applied in multiple axes. First segment 104 and end segment 108 can complement the angled segment 106 to, for example, facilitate convenient assembly and production without compromising the magnitude of force that angled segment 106 can absorb.

Angled segment 106 can absorb forces along its longitudinal axis that include a horizontal component (e.g., parallel to Y-axis) and a vertical component (e.g., parallel to Z-axis). For example, a force applied along the length of angled segment 106 can include a horizontal component that is directly proportional to Cosine(decline angle 110) and a vertical component that is directly proportional to Sine(decline angle 110). A greater decline angle 110 can increase the vertical force (e.g., parallel to Z-axis 50) that angled segment 106 absorbs, and a smaller decline angle 110 can increase the horizontal force (e.g., parallel to Y-axis 40) that angled segment 106 absorbs. In some embodiments, decline angle 110 is between 10° and 60°. In some embodiments, decline angle 110 is between 10° and 20°, 20° and 30°, 30° and 40°, 40° and 50°, or 50° and 60°.

In some embodiments, receiver 204 is disposed directly above stinger 300 in the closed configuration. In some embodiments, as shown for example in FIGS. 5-6, first arm 100 includes a first arm length 102 and second arm includes a second arm length 202 that is substantially the same as first arm length 102. In some embodiments, a ratio of second arm length 202 to first arm length 102 is between 0.95 and 1.05. In some embodiments, as shown for example in FIG. 6, a receiver longitudinal axis 206 is coplanar with a stinger longitudinal axis 302 in the closed configuration, relative to a plane parallel with the XZ plane. Aligning receiver longitudinal axis 206 with stinger longitudinal axis 302 in the closed configuration can support an increased angled segment length 107 (to mitigate vibrations induced by forces in multiple axes). Aligning receiver longitudinal axis 206 with stinger longitudinal axis 302 in the closed configuration can also reduce, or eliminate, a moment arm parallel to Y-axis 40 and extending between the load (e.g., bicycle rack) and stinger 300. This can mitigate vibrations introduced by, for example, a moment applied about stinger 300 by a downward force applied on receiver 204 (e.g., bicycle rack).

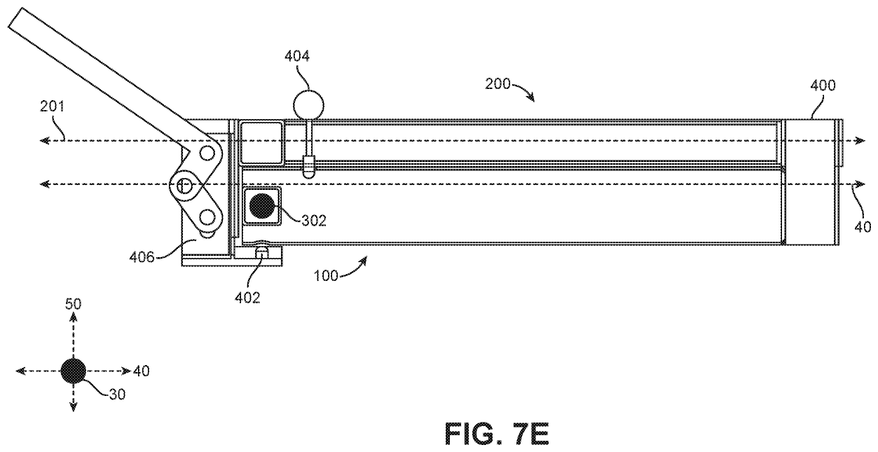

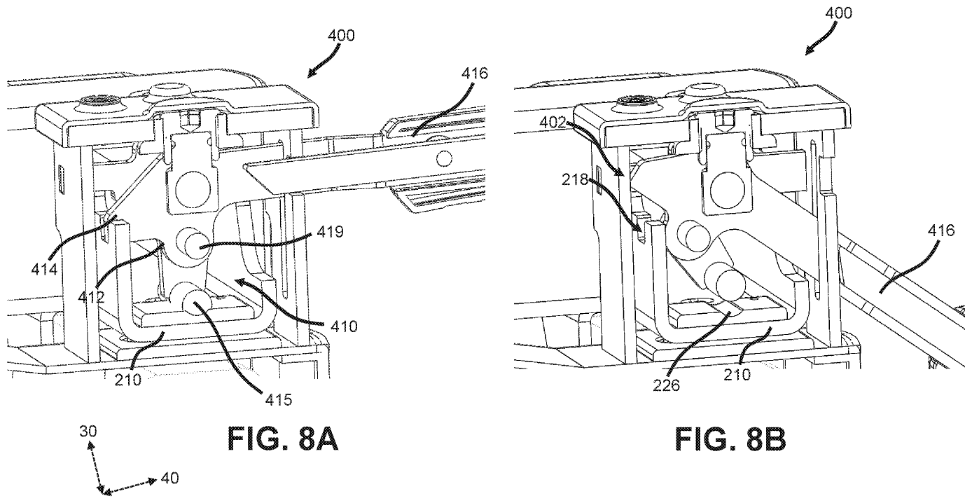

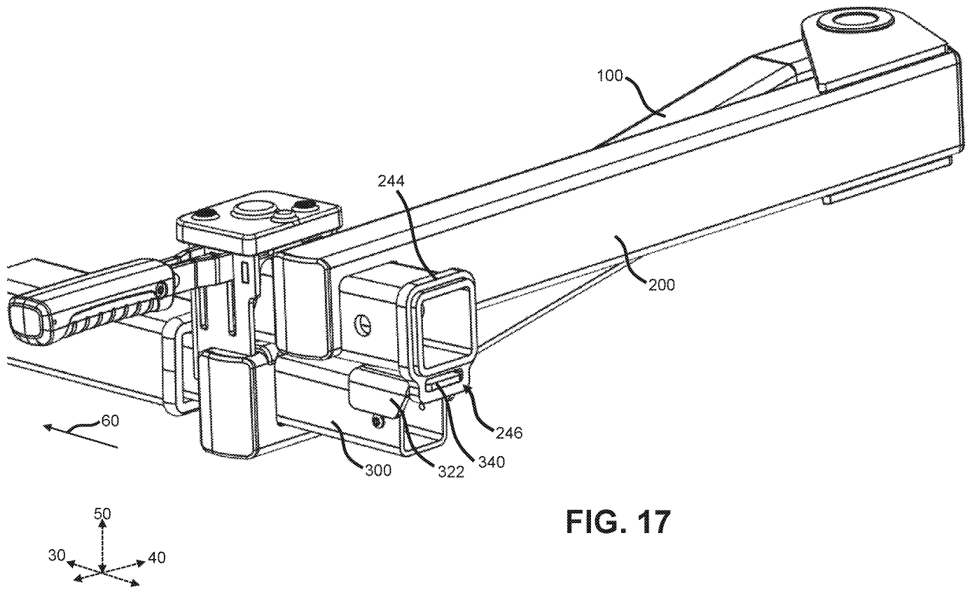

In some embodiments, as shown for example in FIGS. 7A-7E, hitch adapter 10 includes a first lock 402 and a second lock 404 configured to resist rotation of, for example, second arm 200 relative to a plane parallel to the YZ plane (e.g., about Y-axis 40 or an axis parallel to Y-axis 40 and extending through second arm 200, such as a longitudinal axis 201 of second arm 200). In some embodiments, as shown for example in FIGS. 7A-7B, first lock 402 and second lock 404 are disposed on opposite sides of second arm longitudinal axis 201. In some embodiments, as shown for example in FIG. 7C, first lock is configured to apply first lock force 402f and a corresponding first lock normal force 402n about longitudinal axis 201. In some embodiments, for example, first lock 402 is configured to apply a compressive downward first lock force 402f (e.g., on receiver 204 coupled to second arm 200) that prevents upward vertical displacement of second arm 200 when, for example, a vehicle carrying hitch adapter 10 drives over a bump (e.g., speed bump). In some embodiments, as shown for example in FIG. 7C, second lock 404 is configured to apply a second lock force 404f and a corresponding second lock normal force 404n. In some embodiments, for example, second lock 404 is configured to apply a downward second lock force 404f (e.g., on receiver 204 coupled to second arm 200) that prevents upward vertical displacement of second arm 200 when, for example, a vehicle carrying hitch adapter 10 drives over a bump (e.g., speed bump). In some embodiments, for example, first lock 402 is configured to produce a first moment 402m about second arm longitudinal axis 201 in a first direction and second lock 404 is configured to produce a second moment 404m about second arm longitudinal axis 201 in a second direction opposing the first direction. In some embodiments, as shown for example in FIG. 7C, first lock 402 is configured to produce a counterclockwise moment 402m about second arm longitudinal axis 201 (e.g., as discussed relative to FIG. 8A) and second lock 404 is configured to produce a clockwise moment 404m about second arm longitudinal axis 201 (e.g., as discussed relative to FIG. 17) when, for example, a vehicle carrying hitch adapter 10 drives over a bump (e.g., speed bump). Lock 402 and lock 404 disposed on opposite sides of second arm longitudinal axis 201 can produce opposing moments that mitigate vibrations and rotation of second arm 200 when, for example, a vehicle drives over a bump (e.g., speed bump).

Example structures of first lock 402 and/or second lock 404 (e.g., key 410, latch 210, catch 340, and collar 244) are discussed in detail below, but do not constitute an exhaustive or exclusive disclosure of components forming lock 402 and/or lock 404 that produce opposing moments to mitigate rotation and vibration of second arm 200 relative to a plane parallel to the YZ plane.

For example, as shown in FIG. 7D, in some embodiments hitch adapter 10 includes first lock 402 (e.g., pin) and second lock 404 (e.g., pin) disposed on opposite sides of second arm longitudinal axis 201. In some embodiments, as shown for example in FIG. 7D, first lock 402 and second lock 404 produce opposing moments about second arm longitudinal axis 201 via a clamping force provided by, for example, a clamp 406 configured to compress a locking plate 408 coupled to housing 400 with first lock 402 and second lock 404.

As another example, as shown in FIG. 7E, in some embodiments hitch adapter 10 includes first lock 402 and second lock 404 disposed vertically (e.g., parallel to Z-axis 50) relative to Y-axis 40 or an axis parallel to Y-axis 40 and extending through second arm 200 or first arm 100. In some embodiments, as shown for example in FIG. 7E, first lock 402 is disposed below, and second lock 404 is disposed above Y-axis 40 or an axis parallel to Y-axis 40 and extending through second arm 200 or first arm 100. In some embodiments, first lock 402 is disposed below second arm longitudinal axis 201 and second lock 404 is disposed above second arm longitudinal axis 201. In some embodiment, as shown for example in FIG. 7E, first lock 402 (e.g., pin) is configured to engage first arm 100 via a clamping force provided by, for example clamp 406. In some embodiments, second lock 404 is a spring-biased pin configured to produce an opposing moment about Y-axis 40 or an axis parallel to Y-axis 40 and extending through second arm 200 or first arm 100 relative to first lock 402.

In some embodiments, first lock 402 and second lock 404 are configured to provide opposing moments about axes parallel to X-axis 30, Y-axis 40, and/or Z-axis 50. In some embodiments, for example, first lock 402 and second lock 404 are disposed on opposite sides of stinger longitudinal axis 302 (e.g., parallel to X-axis 30) and are configured to produce opposing moments about stinger longitudinal axis 301 to mitigate vibrations and rotation of, for example, second arm 200.

As noted throughout this disclosure, the example structures disclosed herein are not exhaustive. In some embodiments, for example, first lock 402 is disposed at second arm longitudinal axis 201 and second lock 404 is laterally spaced from first lock 402. In some embodiments, for example, hitch adapter 10 includes clamp 406 (shown for example in FIG. 7D) that is first lock 402, disposed at second arm longitudinal axis 201 and includes second lock 404 laterally spaced from clamp 406. In some embodiments, hitch adapter 10 includes two locks configured to mitigate vibrations and rotation of, for example, second arm 200 in the closed configuration.

The locations illustrated for first lock 402 and second lock 404 are for example and are not exhaustive. In some embodiments, as shown for example in FIGS. 7C-7D, first lock 402 is disposed at a first lock lateral distance L1 from second arm longitudinal axis 201 and second lock 404 is disposed at a second lock lateral distance L2 from second arm longitudinal axis 201. As an example, FIG. 7C illustrates first lock 402 and second lock 404 disposed at greater lateral distances L1, L2 from second arm longitudinal axis 201 than illustrated in FIG. 7D. In some embodiments, first lock 402 can be closer to second arm longitudinal axis 201 than second lock 404 is, and vice versa.

In some embodiments receiver 204 includes a receiver length L3. In some embodiments, a ratio of first lock lateral distance L1 to receiver length L3 is between 0 and 1 and a ratio of second lock lateral distance L2 to receiver length L3 is between 0 and 1. In some embodiments, a ratio of first lock lateral distance L1 to receiver length L3 is between 0 and 0.5, or between 0.5 and 1. In some embodiments, a ratio of second lock lateral distance L2 to receiver length L3 is between 0 and 0.5, or between 0.5 and 1. In some embodiments, a ratio of first lock lateral distance L1 to receiver length L3 is between 0 and 0.25, 0.25 and 0.5, 0.5 and 0.75, or between 0.75 and 1. In some embodiments, a ratio of second lock lateral distance L2 to receiver length L3 is between 0 and 0.25, 0.25 and 0.5, 0.5 and 0.75, or between 0.75 and 1.

As an example, in some embodiments receiver length L3 is approximately 30 centimeters, second arm longitudinal axis 201 equally bisects receiver 204, first lock 402 is disposed at first lock lateral distance L1 of approximately 10 centimeters, and second lock 404 is disposed at second lock lateral distance L2 of approximately 5 centimeters. In such an example embodiment, the ratio between first lock lateral distance L1 and receiver length L3 is approximately 0.33 and the ratio between second lock lateral distance L2 and receiver length L3 is approximately 0.16.

As discussed above, the structures discussed below (e.g., key 410, latch 210, catch 340, and collar 244) are non-limiting examples of first lock 402 and/or second lock 404.

In some embodiments, as shown for example in FIGS. 8A-8B, hitch adapter 10 includes a key 410 configured to couple to housing 400 and a latch 210 disposed on receiver first portion 208. In some embodiments, at least a portion of latch 210 is configured to receive and/or abut at least a portion of key 410 in the closed configuration to lock second arm 200.

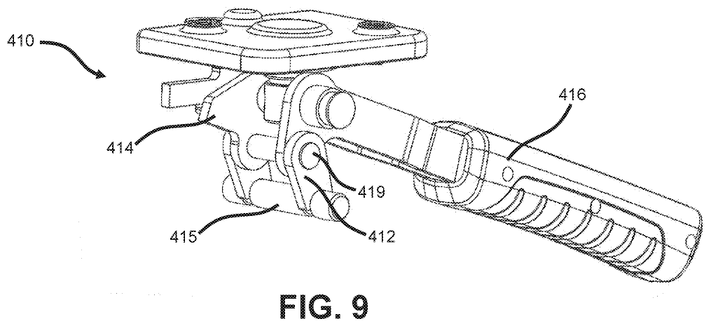

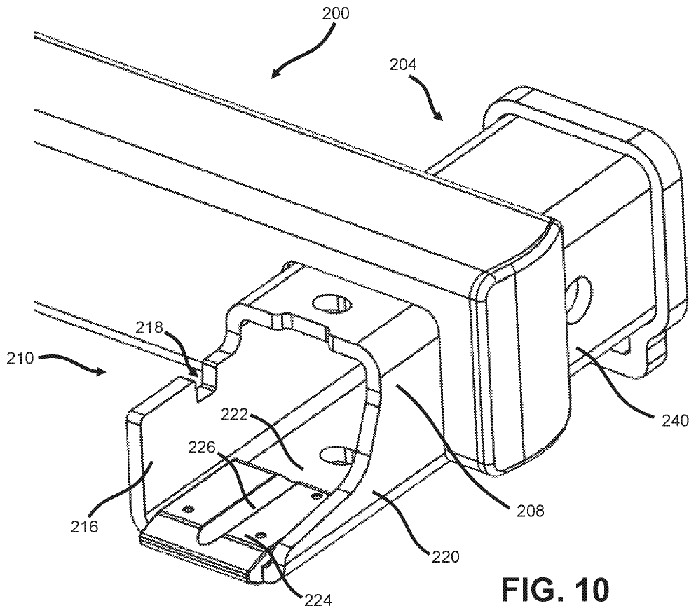

In some embodiments, as shown for example in FIG. 9, key 410 includes a jaw 414 and/or a stop 415 coupled by a linkage 412. In some embodiments, linkage 412 forms a knee joint 419 configured so that linkage 412 rotates upward about knee joint 419 to release key 410 from latch 210, and rotates downward about knee joint 419 (e.g., into latch 210) to move key 410 into latch 210. In some embodiments, as shown for example, in FIG. 10, first portion 208 of receiver 204 includes a latch 210 configured to receive key 410 inside housing 400 in the closed configuration. In some embodiments, latch 210 includes a first side wall 216, a second side wall 220, and a floor 222. In some embodiments, latch 210 includes a first slot 218 disposed in first side wall 216. In some embodiments, latch 210 includes a second slot 226 disposed on floor 222. In some embodiments, as shown for example in FIG. 10, latch 210 includes a wedge 224 disposed on and/or forming part of floor 222, and second slot 226 is disposed on wedge 224.

In some embodiments, as shown for example in FIG. 8A, first slot 218 is configured to receive jaw 414 of key 410 in the closed configuration. First slot 218 and jaw 414 can resist vibrations and movement parallel to X-axis 30 (e.g., vehicle direction 60). In some embodiments, as shown for example in FIG. 8B, second slot 226 is a groove configured to receive stop 415 in the closed configuration. In some embodiments, second slot 226 is a groove, recesses, or other structure configured to receive stop 415. The compression of linkage 412 into second slot 226 can mitigate vibrations and movement parallel to the Y-axis (e.g., horizontal). In some embodiments, first slot 218 and jaw 414 resist vibrations and movement parallel to X-axis 30, and linkage 412 and second slot 226 mitigate vibrations and movement parallel to Y-axis 40.

In some embodiments, first slot 218 is configured to receive jaw 414 and resist vibration and movement parallel to Y-axis 40 (e.g., horizontal). For example, in some embodiments first slot 218 extends parallel to Y-axis 40 (e.g., orthogonal relative to first slot 218 in FIGS. 8A-8B) and jaw 414 extends parallel to X-axis 30 (e.g., orthogonal relative jaw 414 in FIGS. 8A-8B). In some embodiments, first slot 218 is configured to receive jaw 414 and resist vibration and movement parallel to both X-axis 30 and Y-axis 40. For example, in some embodiments, first slot 218 is enclosed around its perimeter and jaw 414 includes a protrusion extending downward into first slot 218.

In some embodiments, second slot 226 is configured to receive stop 415 and resist vibrations and movement parallel to X-axis 30. For example, in some embodiments second slot 226 extends parallel to Y-axis 40 (e.g., orthogonal relative to second slot 226 in FIGS. 8A-8B) and linkage 412 includes a portion extending parallel to X-axis 30 (e.g., orthogonal relative linkage 412 in FIGS. 8A-8B). In some embodiments, second slot 226 is configured to receive stop 415 and resist vibration and movement parallel to both X-axis 30 and Y-axis 40. For example, in some embodiments, second slot 226 is enclosed around its perimeter and is configured to surround stop 415.

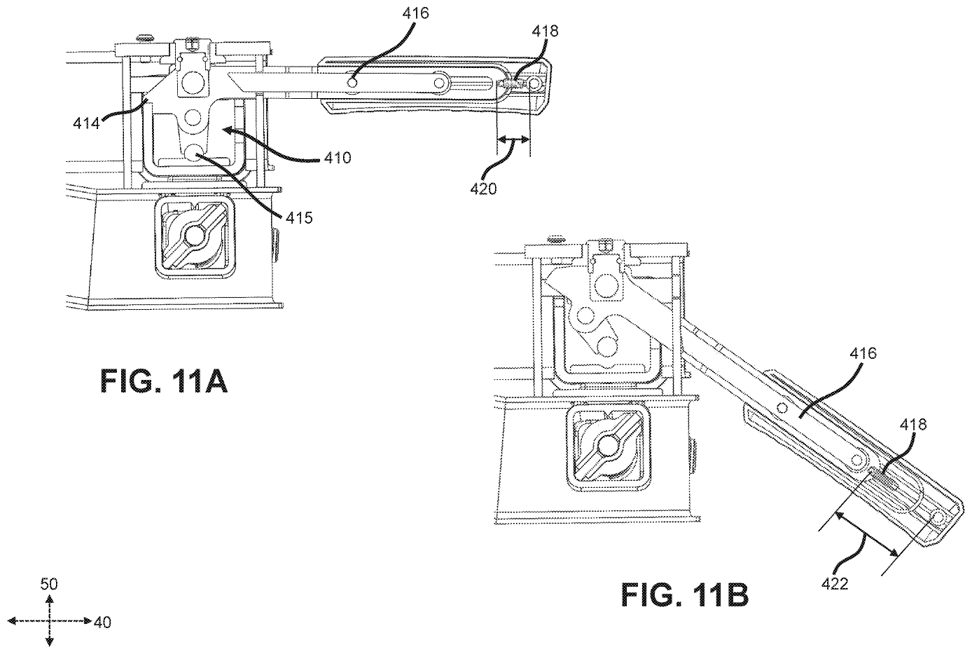

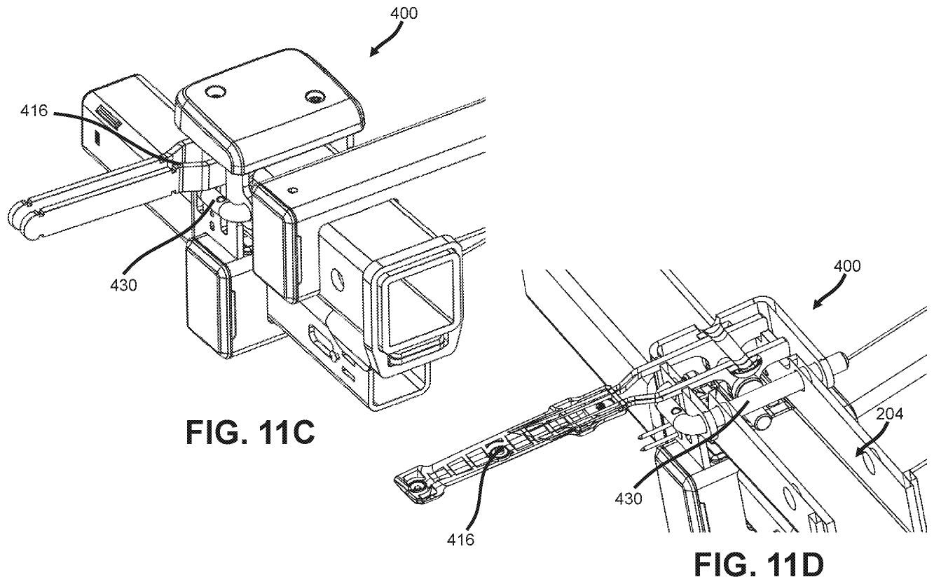

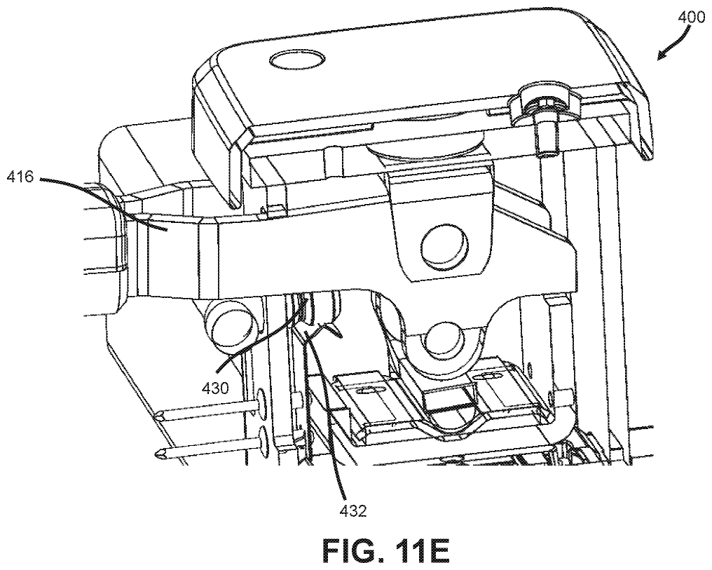

In some embodiments, as shown for example in FIGS. 11A-11B, stop 410 is coupled to an actuator 416 configured to rotate key 410 to, for example, release key 410 from latch 210 so a user can rotate second arm 200 to the open configuration. In some embodiments, as shown for example in FIG. 11A, displacing actuator 416 upward compresses jaw 414 into first slot 218 and/or compresses stop 415 into second slot 226. In some embodiments, as shown for example in FIG. 11B, displacing actuator 416 downward rotates linkage 412 upward so that, for example, stop 415 exits second slot 226 and a user can swing second arm 200 to the open configuration.

In some embodiments, as shown for example in FIGS. 11A-11B, actuator 416 includes a biasing member 418 configured to resist unlocking in the closed configuration by applying a force on key 410 parallel to the Y-axis (e.g., horizontal). In some embodiments, as shown for example in FIGS. 11A-11B, actuator 416 expands in the open configuration from a compressed length 420 to an uncompressed length 422. For example, a user can unlock second arm 200 by pulling actuator 416 outward, and then pressing actuator 416 down to release key 410. In some embodiments, a user can unlock second arm 200 by twisting actuator 416. In some embodiments, a user can unlock second arm 200 by twisting actuator 416 and pushing actuator 416 downward. In some embodiments, a user can unlock second arm 200 by twisting actuator 416, pulling actuator 416 outward, and then pressing actuator 416 down. In some embodiments, actuator 416 is configured to unlock second arm 200 when a user pushes and/or pulls actuator 416 upward. In some embodiments, actuator 416 is configured to lock second arm 200 with housing 400 when a user pushes actuator 416 down.

In some embodiments, biasing member 418 includes a stiffness sufficient to resist inadvertent release of key 410 and, for example, a user would have to apply a force sufficient to overcome the stiffness of biasing member 418 to release key 410 and pivot second arm 200 into the open configuration. In some embodiments, for example, a stiffness coefficient of biasing member 418 is between 500 and 1500 N/M. In some embodiments, the stiffness coefficient of biasing member 418 is between 500 N/M and 750 N/M, 750 N/M and 1000 N/M, 1000 N/M and 1250 N/M, or 1250 N/M and 1500 N/M.

In some embodiments, as shown for example in FIG. 11C, hitch adapter 10 includes an actuator restraint 430 configured to abut actuator 416 in the closed configuration to prevent, for example, actuator 416 from inadvertently pivoting (e.g., downward) to unlock second arm 200. In some embodiments, as shown for example in FIG. 11C, actuator restraint is a pin (e.g., U-shaped pin) configured to protrude from housing 400 and abut actuator 416 in the closed configuration. In some embodiments, housing 400 is configured to receive at least a portion of actuator restraint 430 (e.g., U-shaped pin) in the closed configuration. In some embodiments, as shown for example in FIG. 11D, at least a portion of actuator restraint 430 is configured to extend through at least a portion of housing 400 and at least a portion of receiver 204 in the closed configuration. In some embodiments, as shown for example in FIG. 11E, a resilient plate 432 is configured to abut actuator restraint 430 and bias actuator restraint 430 to prevent actuator restraint 430 from inadvertently exiting housing 400 and/or receiver 204. In some embodiments, resilient plate 432 is disposed inside housing 400. In some embodiments, resilient plate 432 is configured to couple to an exterior surface of housing 400.

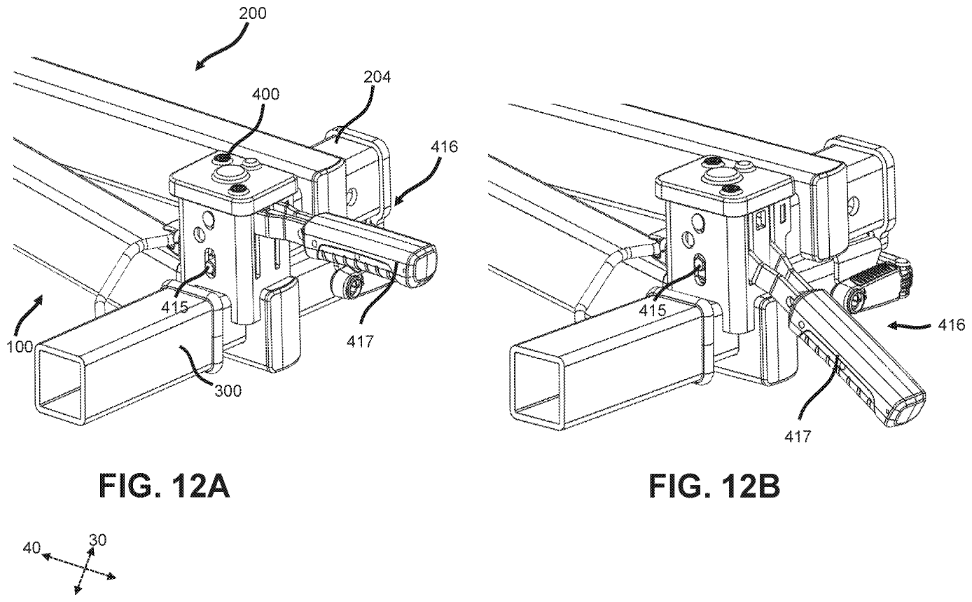

In some embodiments, as shown for example in FIGS. 12A-12B, actuator 416 includes a handle 417 disposed parallel to Y-axis 40. In some embodiments, actuator 416 includes a lever or knob. Orienting actuator 416 parallel to Y-axis 40 can mitigate interference between actuator 416 and, for example, the rear compartment of a vehicle, so a user can access the rear compartment while hitch adapter 10 is attached to vehicle hitch receiver 20.

In some embodiments, as shown for example in FIG. 13, actuator 416 is disposed parallel to X-axis 30 and extends away from vehicle direction 60. Orienting actuator 416 parallel to X-axis 30 and extending away from vehicle direction 60 can provide access to actuator 416 without, for example, reaching around a bicycle rack attached to receiver 204. In some embodiments, actuator 416 is configured to unlock second arm 200 when a user pushes and/or pulls actuator 416 upward. In some embodiments, actuator 416 is configured to lock second arm 200 with housing 400 when a user pushes actuator 416 down. In some embodiments, actuator 416 as shown for example in FIG. 13 is configured to operate similarly to actuator 416 as shown in FIGS. 12A-12B (e.g., a user can unlock second arm 200 by pulling actuator 416 outward, and actuator 416 includes biasing member 418 in some embodiments).

In some embodiments, hitch adapter includes features (e.g., brace 322 and wedge 224) to align second arm 200 into housing 400 when transitioning second arm 200 from the open configuration to the closed configuration. Improper alignment between receiver first portion 208 and housing 400 may introduce undesirable forces applied by the user to lock second arm 200 in the closed configuration, and may introduce vibrations and movement of hitch adapter 10.

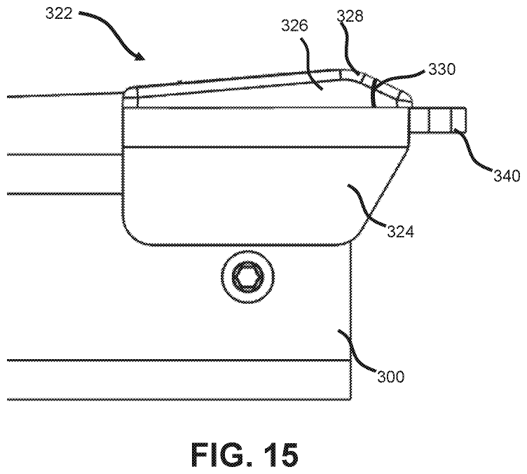

In some embodiments, as shown for example in FIGS. 14-16, brace 322 and first portion 208 of receiver 204 are configured to align receiver 204 for consistent entry into housing 400. In some embodiments, as shown for example in FIG. 15, brace 322 includes a base 324 and a ramp 326 disposed on, coupled to, or integral with base 324. In some embodiments, ramp 326 includes a ramp leading edge 328 disposed at a ramp angle 330 relative to base 324. Ramp 326 can guide receiver first portion 208 into a vertical alignment for entry into housing 400 while mitigating the force that a user applies to move second arm 200 into the closed configuration. This can prevent a user from improperly locking second arm 200 inside housing 400, which can introduce stresses in hitch adapter 10 and noise during use (e.g., driving). In some embodiments, ramp angle 330 is between 10° and 60°. In some embodiments, ramp angle 330 is between 10° and 20°, 20°and 30°, 30°and 40°, 40°and 50°, or 50°and 60°.

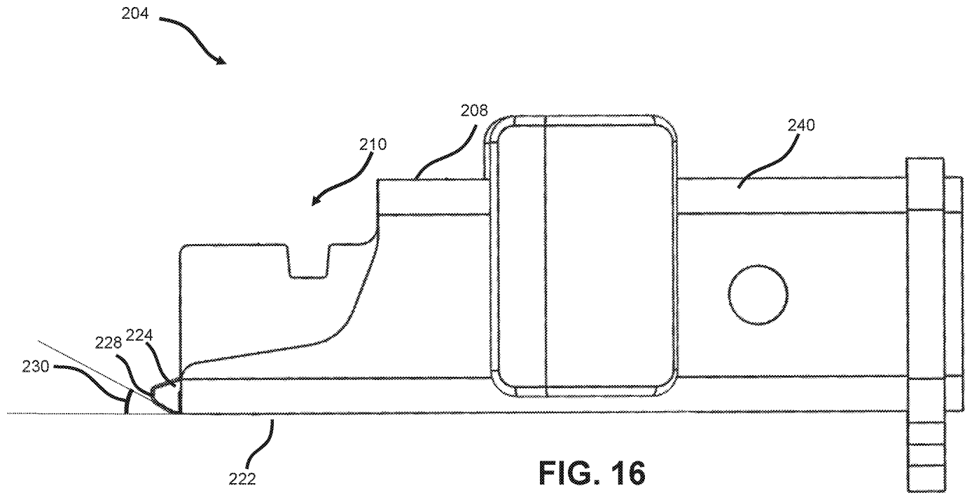

In some embodiments, as shown for example in FIG. 16, receiver first portion 208 includes wedge 224 configured to engage ramp 326 when second arm 200 moves to the closed configuration. In some embodiments, wedge 224 includes a wedge leading edge 228 disposed at a wedge incidence angle 230 relative to floor 222 of latch 210. Wedge incidence angle 230 can complement ramp angle 330 to guide a smooth transition (e.g., mitigate force applied by user) of receiver 204 into housing 400 to lock second arm 200 in the closed configuration. In some embodiments, wedge incidence angle 230 is between 10° and 60°. In some embodiments, ramp angle 330 is between 10° and 20°, 20° and 30°, 30° and 40°, 40° and 50°, or 50° and 60°. Wedge 224 and ramp 326 can consistently guide receiver 204 into housing 400 to lock second arm 200 in the closed configuration and mitigate potential improper locking and associated undesirable force and stresses in hitch adapter 10.

In some embodiments, as shown for example in FIG. 17, hitch adapter 10 includes a collar 244 disposed on, around, or integral with second portion 240 of receiver 204. In some embodiments, collar 244 includes an aperture 246 configured to receive a catch 340 disposed on stinger 300. In some embodiments, catch 340 extends from brace 322 opposite vehicle direction 60. In some embodiments, a portion of collar 244 forming aperture 246 is configured to abut a lower surface of catch 340 to resist vibration and movement of second arm 200 parallel to Z-axis 50 in the closed configuration. In some embodiments, aperture 246 and catch 340 can align receiver 204 into housing 400 to lock second arm 200 in the closed configuration. As discussed above, guided alignment mitigates forces applied by a user to lock second arm 200 in the closed configuration, and mitigates stresses that can introduce vibration and movement of hitch adapter 10 during use (e.g., driving).

In some embodiments, as shown for example in FIGS. 18-19, brace 322 is configured to abut at least a portion of receiver 204 in the closed configuration. Brace 322 can apply a normal force to receiver 204 to support second arm 200 in the closed configuration. In some embodiments, brace 322 is disposed on, coupled to, or integrally formed with second portion 320 of stinger 300. In some embodiments, brace 322 is disposed proximate distal end 306 of stinger 300. In some embodiments, as shown for example in FIG. 18, brace 322 extends beyond distal end 306 of stinger 300. Positioning brace 322 closer to the load (e.g., bicycle rack) than to vehicle hitch receiver 20 can reduce bending stress in hitch adapter 10, including stinger 300 in the closed configuration. Brace 322 being disposed proximate the load (e.g., bicycle rack) can mitigate stress (e.g., bending stress) and vibrations in hitch adapter 10 by reducing the cantilevered length and moment arm between the load (e.g., bicycle rack) and the connection between stinger 300 and vehicle hitch receiver 20. In some embodiments, brace 322 reduce stress on second arm 200. For example, a load (e.g., bicycle rack) disposed proximate distal end 306 of stinger 300 can introduce a moment that rotates receiver 204, and second arm 200, about an axis parallel to Y-axis 40. Brace 322 can apply a counter normal force to receiver 204 to mitigate rotation about an axis parallel to Y-axis 40. In some embodiments, hitch adapter 10 is configured to balance moment couples about an axis parallel to X-axis 30, Y-axis 40, and/or Z-axis 50, as discussed above.

In some embodiments, as shown for example in FIGS. 18-19, housing 400 and receiver 204 are disposed at an incline 424 relative to stinger 300 (e.g., axis parallel to X-axis 30) in a plane parallel to the XZ plane. Incline 424 mitigates interference between receiver 204 and stinger 300 in the closed configuration introduce by, for example, a load (e.g., bicycle rack) applied proximate distal end 306 of stinger 300. In some embodiments, incline 424 provides clearance between receiver 204 and stinger 300 (e.g., brace 322) so applying a load (e.g., bicycle rack) proximate distal end 306 of stinger 300 does not introduce undesirable compression between second arm 200 and stinger 300 that may produce stresses and vibrations during use. In some embodiments, incline 424 is between 0.5° and 4.5°. In some embodiments, incline 424 is between 0.5° and 1.5°, 1.5° and 2.5°, 2.5° and 3.5°, or 3.5° and 4.5°.

In some embodiments, rotation joint 500 is configured to mitigate vibration and movement of hitch adapter 10 in the closed configuration. In some embodiments, as shown for example in FIG. 20, rotation joint 500 includes rotation axis 502 extending through first arm 100. Rotation axis 502 extending through first arm 100 can mitigate vibrations and movement of hitch adapter 10 because rotation axis 502 is proximate the vehicle and therefore there is a smaller moment arm between vehicle and rotation joint 500 than if rotation axis 502 extended through second arm 200. In some embodiments, rotation axis 502 extends through second arm 200. Rotation axis 502 extending through second arm 200 can mitigate stress in rotation joint 500 because the load (e.g., bicycle rack) is closer to rotation joint 500 (e.g., less bending stress) than if rotation axis 502 extended through first arm 100.

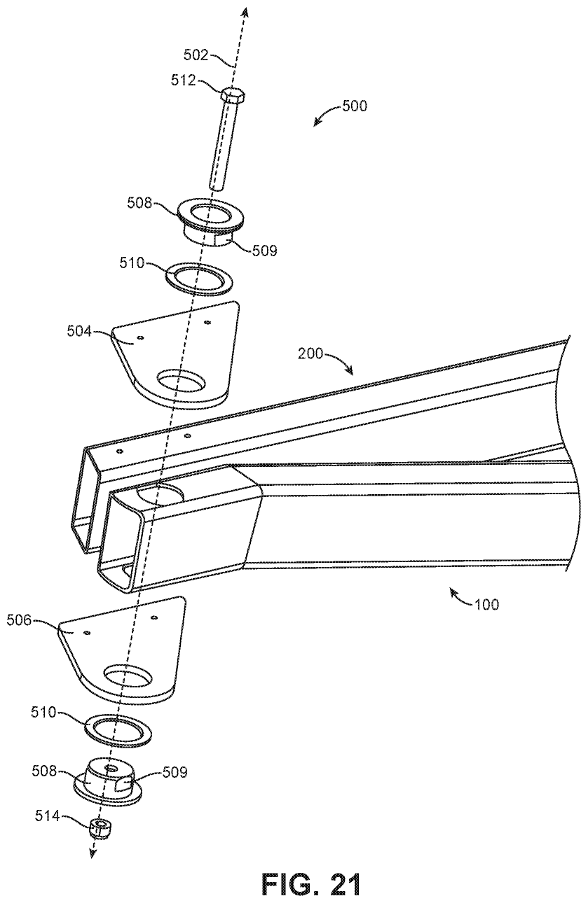

In some embodiments, as shown for example in FIG. 21, rotation joint 500 includes a first pivot plate 504 and a second pivot plate 506 disposed on opposite sides of first arm 100 and second arm 200. In some embodiments, first pivot plate 504 and second pivot plate 506 are configured to pivot about rotation axis 502, and are fixed to second arm 200, such that second arm 200 is configured to pivot about rotation axis 502 extending through first arm 100. In some embodiments, rotation joint 500 includes a fastener, e.g., bolt 512 that is collinear with rotation axis 502. In some embodiments, rotation joint 500 includes at least one bushing 508, at least one washer 510, and/or at least one nut 514, where the at least one bushing 508, at least one washer 510, and/or at least one nut 514 are configured to resist (e.g., by friction) vibrations in rotation joint 500 in the closed configuration. In some embodiments, bushing 508 includes a planar surface 509 configured to resist rotation of bushing 508 and thereby mitigate vibrations in rotation joint 500.

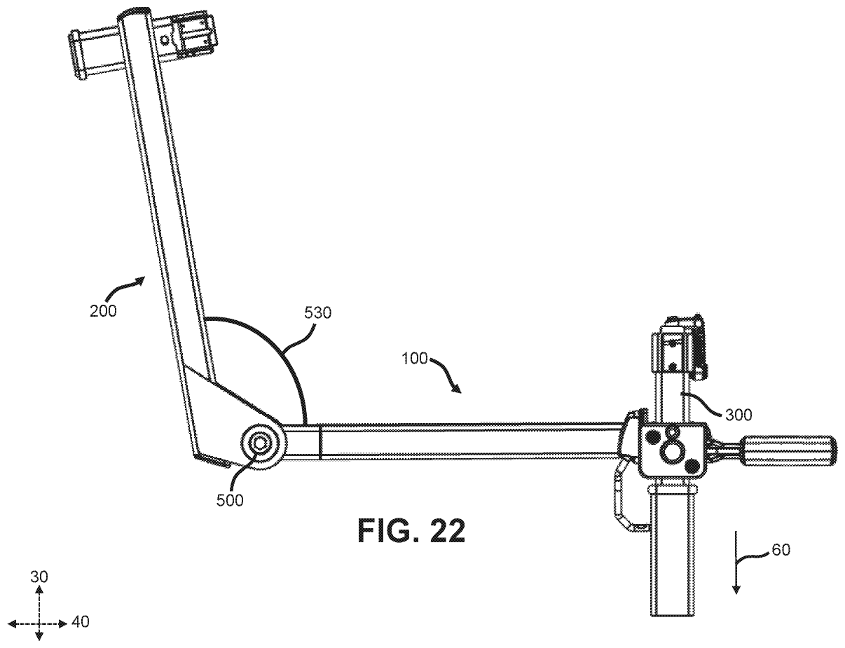

Rotation joint 500 can guide consistent and repeated pivoting of second arm 200 under load (e.g., bicycle rack) while mitigating decreases in durability over repeated use of hitch adapter 10. In some embodiments, as shown for example in FIG. 22, rotation joint 500 is configured to allow second arm 200 to pivot to the open configuration, where first arm 100 and second arm 200 form an open angle 530 greater than or equal to 45° in a plane parallel to the XY plane. In some embodiments, open angle 530 is between 90° and 180°. In some embodiments, open angle 530 is between 90° and 145°. In some embodiments, open angle 530 is between 100° and 130°. In some embodiments, open angle 530 is between 100° and 110°, 110° and 120°, or 120° and 130°.

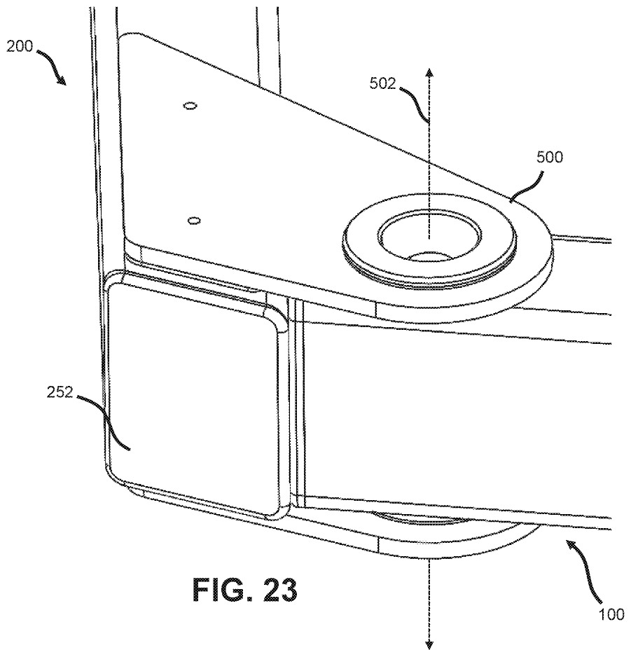

In some embodiments, as shown for example in FIG. 23, second arm 200 includes an end cap 252 disposed proximate rotation joint 500. In some embodiments, end cap 252 is configured to abut first arm 100 in the open configuration (e.g., when second arm 200 is disposed at open angle 530 relative to first arm 100). In some embodiments, end cap 252 is configured to limit the maximum pivoting of second arm 200 to open angle 530 in the open configuration.

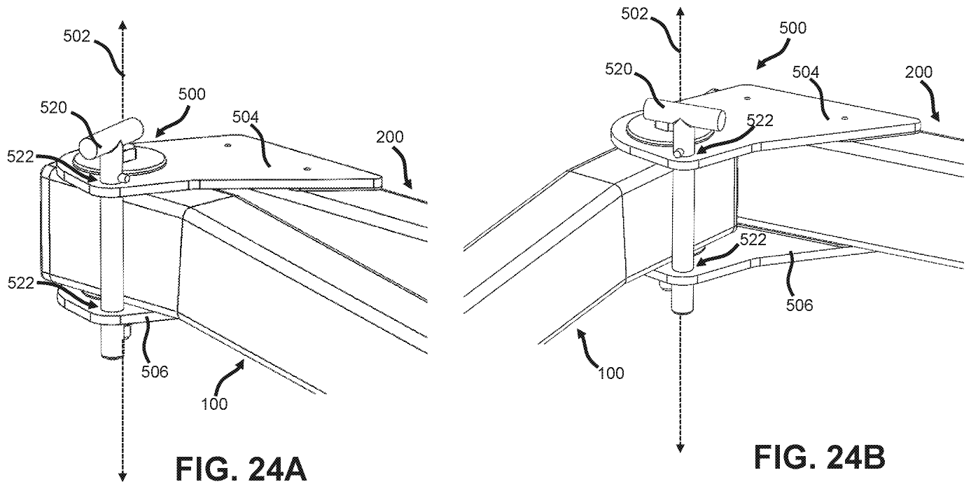

In some embodiments, as shown for example in FIGS. 24A-24B, hitch adapter 10 includes a locking pin 520 for rotation joint 500. In some embodiments, locking pin 520 is configured to extend through first pivot plate 504 and second pivot plate 506. In some embodiments, first pivot plate 504 and second pivot plate 506 include a locking pin aperture 522 configured to receive locking pin 520. In some embodiments, as shown for example in FIG. 24A, locking pin 520 resists rotation of second arm 200 when in the closed configuration because locking pin 520 extends along a different axis relative to rotation axis 502, thereby applying a normal force to second arm 200 in response, and opposition to, a force to rotate second arm 200. In some embodiments, as shown for example in FIG. 24B, locking pin 520 resists rotation of second arm 200 when in the open configuration. For example, locking pin 520 can resist rotation of second arm 200 from the open configurations to the closed configuration because it extends along a different axis than rotation axis 502, thereby applying a normal force to second arm 200 in response, and opposition to, a force to rotate second arm 200. In some embodiments, locking pin 520 applies a normal force to second arm 200 via contact between locking pin 520 and first pivot plate 504 and second pivot plate 506 through locking pin aperture 522.

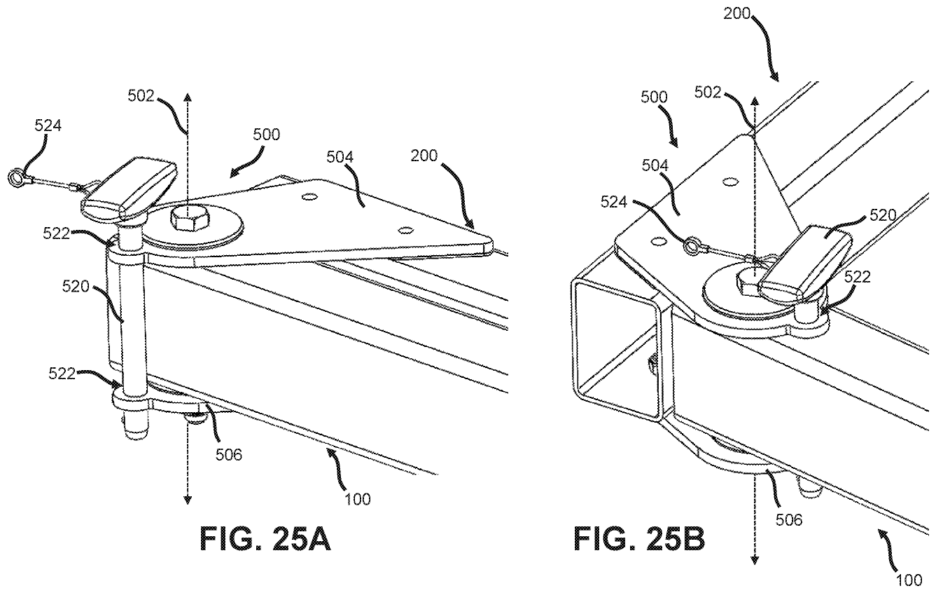

In some embodiments, as shown for example in FIGS. 25A-25B, locking pin 520 is configured to extend through first pivot plate 504 and second pivot plate 506 in the closed configuration, and locking pin 520 is configured to extend through first arm 100 in the open configuration. In some embodiments, as shown for example in FIGS. 25B and 25, first pivot plate 504, second pivot plate 506, and first arm 100 include a locking pin aperture 522 configured to receive locking pin 520. In some embodiments, as shown for example in FIG. 25B, locking pin 520 includes a locking pin latch 524 configured to secure locking pin 520 to rotation joint 500 (e.g., first pivot plate 504).

In some embodiments, locking pin latch 524 is, for example, a cable (e.g., resilient), a spring, a rod (e.g., stiff rod) or any other structure configured to attach to first pivot plate 504 or second pivot plate 506 (e.g., to a protrusion extending from first pivot plate 504 or second pivot plate 506). Locking pin latch 524 can resist pivoting of second arm 200 in the closed configuration through tension that opposes pivoting from the closed configuration to the open configuration, thereby biasing second arm 200 to the closed configuration. Resisting pivoting of second arm 200 in the closed configuration can mitigate vibrations and movement of hitch adapter 10 in the closed configuration.

Locking pin latch 524 can resist pivoting of second arm 200 beyond, for example, open angle 530 in the open configuration. For example, locking pin latch 524 can resist pivoting of second arm 200 beyond open angle 530 through tension that biases second arm 200 to open angle 530 if a user attempts to pivot second arm 200 beyond open angle 530. In some embodiments, locking pin latch 524 can resist pivoting of second arm 200 toward the closed configuration. For example, in some embodiments, locking pin latch 524 is a stiff rod that applies a normal force to second arm 200 opposing rotation of second arm 200 toward the closed configuration.

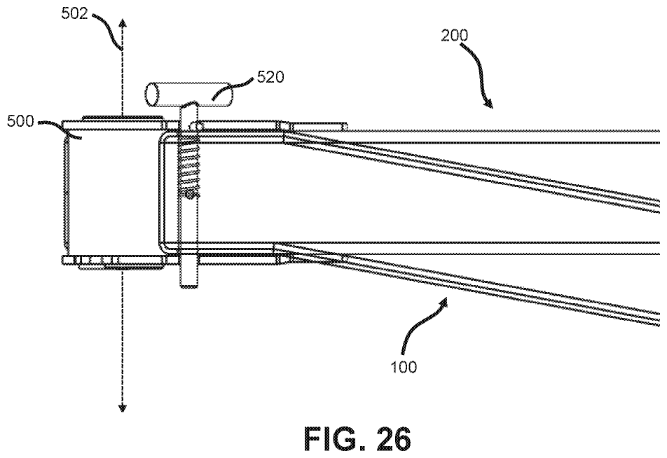

In some embodiments, as shown for example in FIG. 26, locking pin 520 is spring biased to remain in, for example, locking pin aperture 522 and disposed inside first arm 100. A spring biased locking pin mitigates the potential for locking pin 520 to exit during use (e.g., driving). A user can remove locking pin 520 by, for example, applying a sufficient force to overcome the spring stiffness in a spring biased locking pin 520.

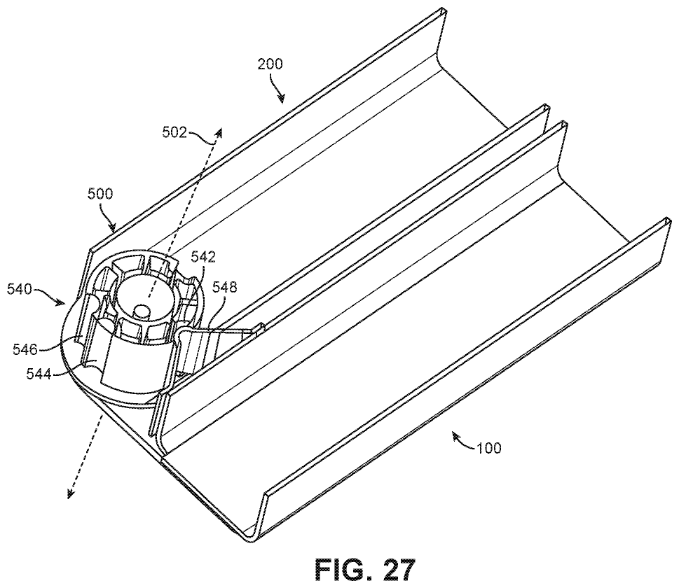

In some embodiments, as shown for example in FIG. 27, hitch adapter 10 includes a swing lock 540 disposed along rotation axis 502. Swing lock 540 can automatically (e.g., without requiring a user to remove or insert locking pin 520) lock second arm 200 at one or more position(s), for example, two or three different positions. In some embodiments, swing lock 540 includes a first stay 542, a second stay 544, and a third stay 546, where first stay 542, second stay 544, and third stay 546 are configured to resist rotation of second arm 200 in a plurality of positions. In some embodiments, as shown for example in FIG. 27, swing lock 540 includes a tab 548. In some embodiments, first stay 542, second stay 544, and third stay 546 are configured to receive tab 548 to resist rotation of second arm 200 at a plurality of positions. In some embodiments, tab 548 is resilient, such that tab 548 compresses toward first arm 100 when, for example, a user applies sufficient rotation force to second arm 200. When tab 548 is sufficiently compressed toward first arm 100, second arm 200 can be free to rotate (e.g., not restrained by first stay 542, second stay 544, or third stay 546) until, for example, first stay 542, second stay 544, or third stay 546 receives tab 548.

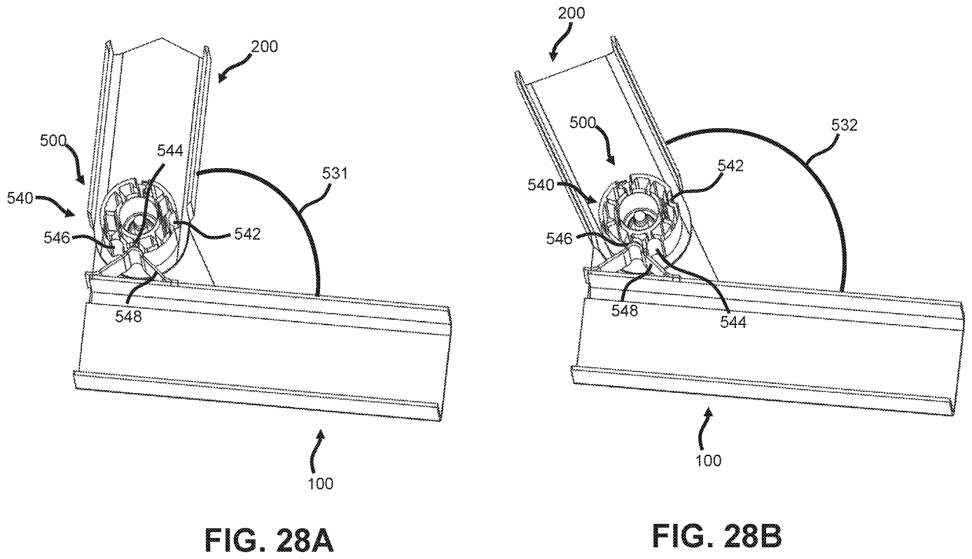

In some embodiments, as shown for example in FIG. 27, first stay 542 is configured to receive tab 548 in the closed configuration, to resist rotation of second arm 200 from the closed configuration to the open configuration. In some embodiments, as shown for example in FIG. 28A, second stay 544 is configured to receive tab 548 in the open configuration, to resist rotation of second arm 200 past a first open angle 531. In some embodiments, as shown for example in FIG. 28B, second stay 544 is configured to receive tab 548 in the open configuration, to resist rotation of second arm 200 past a second open angle 532 that is greater than first open angle 531.

In some embodiments, first open angle 531 is between 45° and 120°. In some embodiments, first open angle is between 60° and 75°, or 75° and 90°. In some embodiments, second open angle 532 is between 90° and 180°. In some embodiments, second open angle 532 is between 90° and 135°, or 135° and 180°. In some embodiments, second open angle 532 is between 90° and 100°, 100° and 110°, 110° and 120°, 120° and 130°, 130°and 140°, 140°and 150°, 150° and 160°, 160° and 170°, or 170° and 180°.

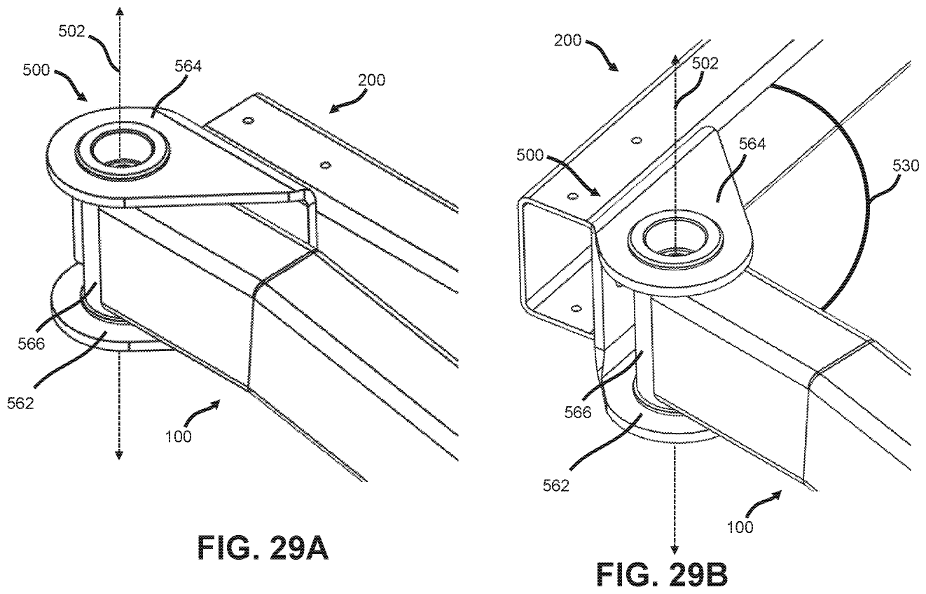

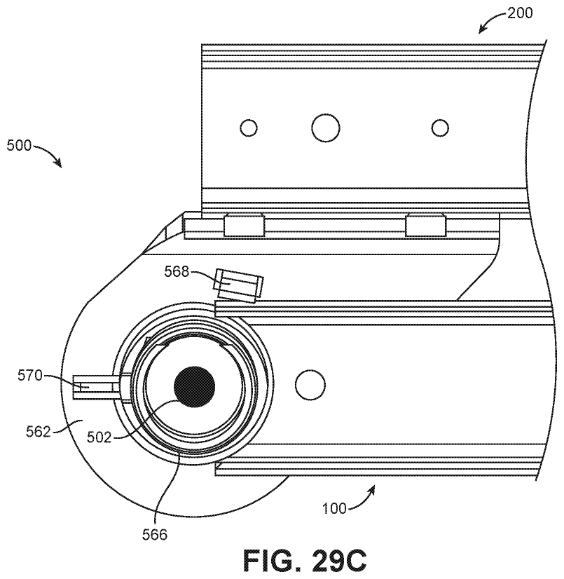

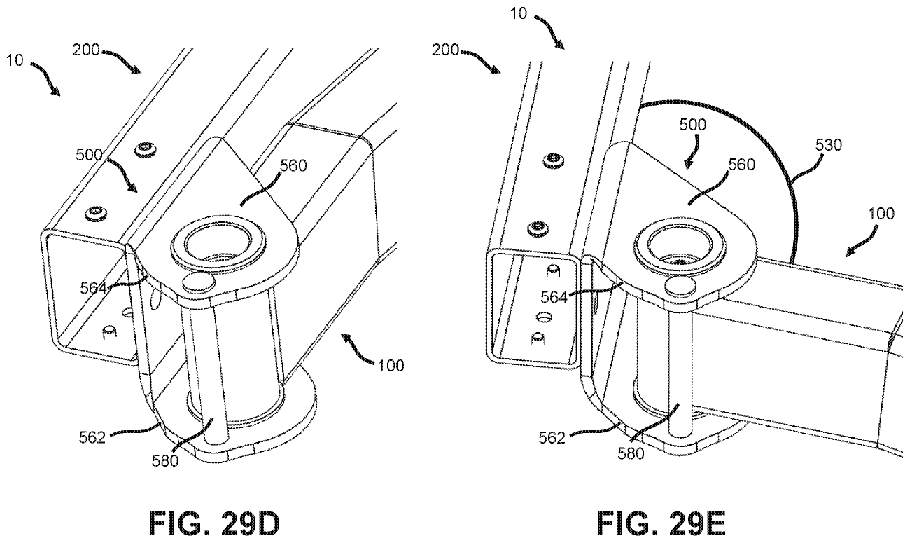

In some embodiments, as shown for example in FIGS. 29A-29C, rotation joint 500 includes a bracket 560 (e.g., U-shaped bracket) coupled to second arm 200. In some embodiments, bracket 560 includes a floor 562 and ceiling 564 and a barrel 566 disposed therebetween. In some embodiments, bracket 560 is integral with (e.g., welded to) second arm 200. In some embodiments, bracket 560 is spaced (e.g., vertically) from first arm 100 to, for example, provide access for welding first arm 100 and rotation joint 500. In some embodiments, for example, floor 562 of bracket 560 is disposed below at least a portion of first arm 100 and ceiling 564 of bracket 560 is disposed above at a least a portion of first arm 100.

In some embodiments, as shown for example in FIG. 29C, rotation joint 500 includes a first protrusion 568 disposed on, for example, floor 562 of bracket 560, and a second protrusion 570 disposed on, for example, barrel 566. In some embodiments, first protrusion 568 is configured to rotate about rotation axis 502 and is configured to abut second protrusion 570 when second arm 200 is disposed at open angle 530 relative to first arm 100.

In some embodiments, as shown for example in FIGS. 29D-29E, hitch adapter 10 includes a stop member 580 configured to resist rotation of second arm 200 past open angle 530 in the open configuration. In some embodiments, stop member 580 is configured to abut first arm 100 in the closed configuration. In some embodiments, at least a portion of stop member 580 is disposed between floor 562 of bracket 560 and ceiling 564 of bracket 560. In some embodiments, stop member 580 is parallel with rotation axis 502. In some embodiments, stop member 580 is parallel with rotation axis 502 and spaced from rotation axis 502. In some embodiments, at least a portion of stop member 580 extends through bracket 560. In some embodiments, stop member 580 is cylindrical. In some embodiments, stop member 580 is rectangular, trapezoidal, triangular, etc.

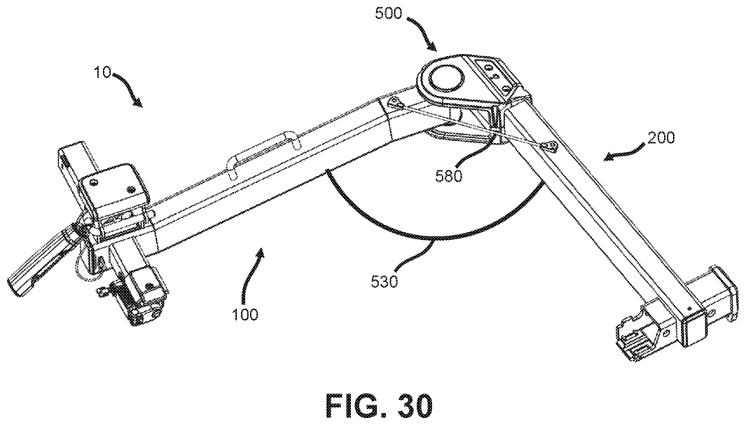

In some embodiments, as shown for example in FIG. 30, hitch adapter 10 stop member 580 is wire, cable, expandable rod, telescoping rod, collapsible rod, foldable rod, etc. In some embodiments, stop member 580 is coupled to first arm 100 and second arm 200. In some embodiments, stop member 580 is configured to prevent rotation of second arm 200 past open angle 530. In some embodiments, for example, stop member 580 is configured to produce a tensile force that prevents rotation of second arm 200 past open angle 530.

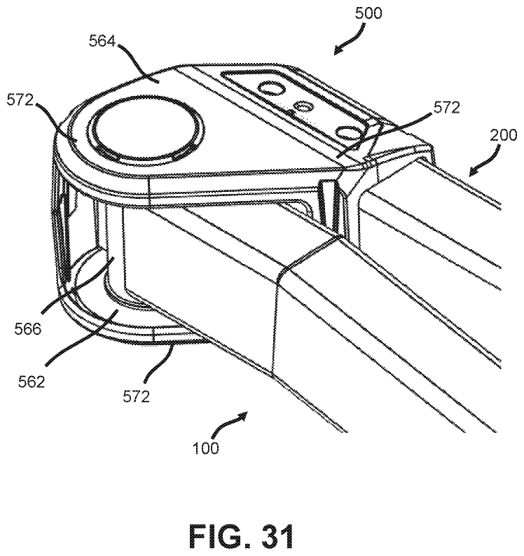

In some embodiments, as shown for example in FIG. 31, rotation joint 500 includes a cover 572 configured to enclose at least a portion of rotation joint 500. In some embodiments, cover 572 is configured to protect rotation joint 500 from damage.

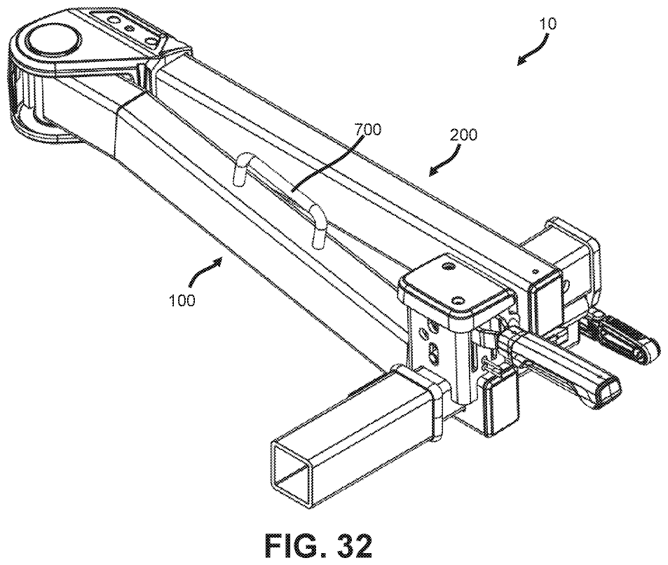

In some embodiments, as shown for example in FIG. 32, hitch adapter 10, as disclosed herein, includes a carry handle 700. In some embodiments, carry handle 700 is disposed on first arm 100. In some embodiments, carry handle 700 is disposed on second arm 200. In some embodiments, carry handle 700 includes more than one handle. For example, in some embodiments, hitch adapter 10 includes one or more carry handles 700 disposed on first arm 100 and/or and one or more carry handles disposed on second arm 200.

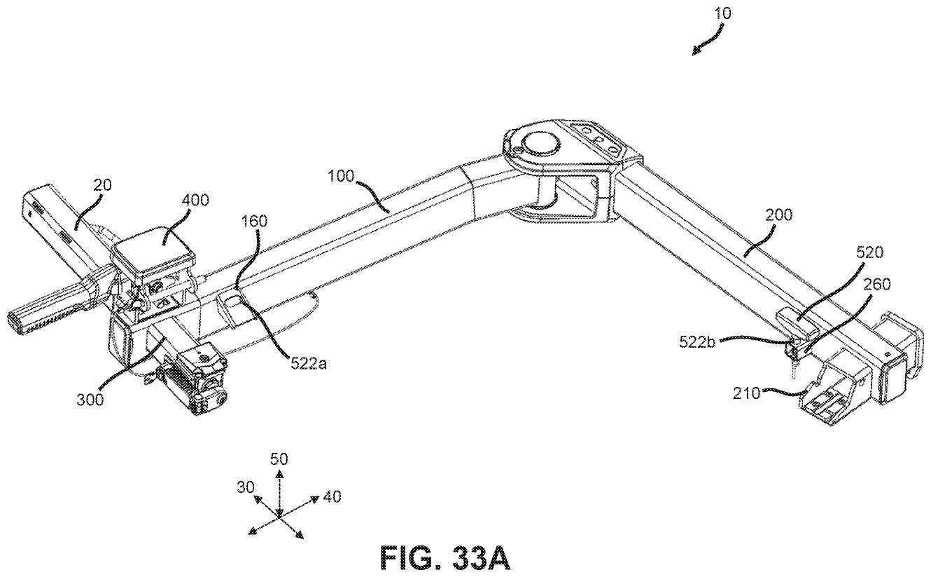

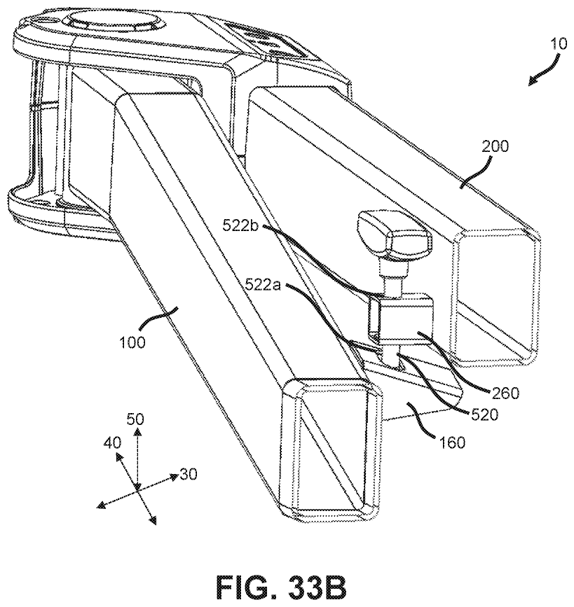

In some embodiments, as shown for example in FIGS. 33A-33B hitch adapter 10 includes receiver latch 210 and housing 400 configured to receive receiver latch 210 in the closed configuration (as shown for example in FIG. 7B). In some embodiments, hitch adapter 10 includes a first arm locking pin aperture 522a and a second arm locking pin aperture 522b. In some embodiments, as shown for example in FIG. 33A, first arm locking pin aperture 522a is disposed in a first arm boss 160 and second arm locking pin aperture 522b is disposed in a second arm boss 260.

In some embodiments, as shown for example in FIGS. 33A-33B, first arm boss 160 extends from first arm 100 in a direction that is generally orthogonal to first arm 100 and second arm boss 260 extends from second arm 200 in a direction that is generally orthogonal to second arm 200. In some embodiments, as shown for example in FIGS. 33A-33B first arm boss 160 includes a tapered body (e.g., triangular, ramp-shaped, wedge-shaped, etc.). In some embodiments, first arm boss 160 is generally shaped as a cube, rectangular prism, parallelogram, wedge, cylinder, etc. or any other structure that can include first arm locking pin aperture 522a. In some embodiments, as shown for example in FIGS. 33A-33B, second arm boss 260 is generally shaped as a rectangular prism. In some embodiments, second arm boss 260 is generally shaped as a cube, rectangular prism, parallelogram, wedge, cylinder, etc. or any other structure that can include second arm locking pin aperture 522b.

In some embodiments, as shown for example in FIG. 33A, second arm boss 260 is configured to receive lock pin 520 via second arm locking pin aperture 522a in the open configuration. In some embodiments, second arm boss 260 configured to receive lock pin 520 in the open configuration provides temporary storage for lock pin 520 to mitigate potential for misplacing lock pin 520 when, for example, moving hitch adapter 10 from the closed configuration to the open configuration.

In some embodiments, lock pin 520 extends through first arm boss 160 and second arm boss 260 to secure second arm 200 when hitch adapter 10 is disposed in the closed configuration. In some embodiments, as shown for example in FIG. 33B, first arm locking pin aperture 522a and second arm locking pin aperture 522b are vertically aligned when hitch adapter 10 is disposed in the closed configuration. In some embodiments, as shown for example in FIG. 33B, second arm boss 260 overlays first arm boss 160 when hitch adapter 10 is disposed in the closed configuration. In some embodiments, first arm boss 160 overlays second arm boss 260 when hitch adapter 10 is disposed in the closed configuration. In some embodiments, first arm boss 160 is configured to receive second arm boss 260, or vice versa, when hitch adapter 10 is in the closed configuration.

In some embodiments, first arm boss 160 and second arm boss 260 independently (e.g., without a separate locking arrangement, such as receiver latch 210 and housing 400) secure second arm 200 in the closed configuration via lock pin 520 extending through first arm locking pin aperture 522a and second arm locking pin aperture 522b. In some embodiments, first arm boss 160 and second arm boss 260 provide a complementary locking arrangement (e.g., in addition to a separate locking arrangement, such as receiver latch 210 and housing 400) to secure second arm 200 in the closed configuration via lock pin 520 extending through first arm locking pin aperture 522a and second arm locking pin aperture 522b. In some embodiments, first arm boss 160 and second arm boss 260 configured to receive lock pin 520 mitigate vibration and rotation of, for example, second arm 200 when hitch adapter 10 is disposed in the closed configuration.

### ASPECTS

The following aspects are non-limiting examples of the embodiments disclosed herein.

### Aspect 1

A hitch adapter 10 comprising a first arm 100 extending parallel relative to a first plane (40, 50) in a closed configuration and a second arm 200 pivotably coupled to the first arm 100. The hitch adapter 10 includes a first lock 402 and a second lock 404 disposed on opposing sides of a longitudinal axis 201 of second arm 200.

### Aspect 2

A hitch adapter 10, according to aspect 1, where the first lock 402 and second lock 404 are configured to produce opposing moments about longitudinal axis 201 of second arm 200.

### Aspect 3

A hitch adapter 10, according to aspect 1, where the first lock 402 and the second lock 404 are configured to restrict rotation about a Y-axis 40.

### Aspect 4

A hitch adapter 10, according to aspect 1, where the first lock 402 and the second lock 404 are configured to restrict rotation about longitudinal axis 201 of second arm 200.

### Aspect 5

A hitch adapter 10 including a first arm 100 extending parallel relative to a first plane (40, 50) in a closed configuration and a second arm 200 pivotably coupled to the first arm 100. The hitch adapter 10 includes a receiver 204 disposed at an end of the second arm 200 and a stinger 300 coupled to and extending orthogonally from the first arm 100 and extending orthogonally relative to the first plane (40,50), and configured to couple to a vehicle hitch receiver. A proximal end 304 of the stinger 300 is configured to engage the vehicle hitch receiver. The first arm 100 and the second arm 200 form an acute angle 110 in the first plane (40, 50) in the closed configuration.

### Aspect 6

A hitch adapter 10, according to aspect 5, where a length 102 of the first arm 100 is approximately the same as a length 202 of the second arm 200.

### Aspect 7

A hitch adapter 10 including a housing 400 disposed at an end of a first arm 100. The housing 400 is configured to receive a portion of a receiver 204 in the closed configuration. The hitch adapter 10 comprises an actuator 416 configured to unlock the receiver 204 from the housing 400, and configured to lock the receiver 204 inside the housing 400.

### Aspect 8

A hitch adapter 10, according to aspect 7, where the actuator 416 is configured to expand a linkage 412.

### Aspect 9

A hitch adapter 10, according to aspect 8, where at least a portion of the linkage 412 is configured to contact a floor 222 of the receiver 204 in the closed configuration.

### Aspect 10

A hitch adapter, 10, according to aspect 8, where the linkage 412 includes a knee joint 419.

### Aspect 11

A hitch adapter 10, including a key 410 configured to lock the second arm 200 in the closed configuration. The key 410 comprises a jaw 414 and/or a stop 415 coupled by a linkage 412.

### Aspect 12

A hitch adapter 10 according to any one, or all, of aspects 7-11, including a latch 210 disposed on a first portion 208 of the receiver 204 and configured to receive the key 410 in the closed configuration.

### Aspect 13

A hitch adapter 10, according to any one, or all, of aspects 7-12, wherein the key 410 comprises a first portion (e.g., jaw 414) and a second portion (e.g., stop 415), the latch 210 comprises a first slot 218 configured to receive the first portion of the key 410, and the latch 210 comprises a second slot 226 configured to receive the second portion of the key 410.

### Aspect 14

A hitch adapter 10, including a brace 322 disposed on an upper surface of a stinger 300 and disposed proximate a distal end 306 of the stinger 300.

### Aspect 15

A hitch adapter 10, according to aspect 14, where a receiver 204 is configured to abut the brace 322 in the closed configuration.

### Aspect 16

A hitch adapter 10, including a catch 340 protruding from a brace 322 and an aperture 246, where the aperture 246 is configured to receive the catch 340 in the closed configuration.

### Aspect 17

A hitch adapter 10, according to aspect 16, where the catch 340 is configured to restrict vertical movement of the second arm 200 in the closed configuration.

### Aspect 18

A hitch adapter 10, including a ramp 326 configured to bias a receiver 204 into vertical alignment with a housing 400.

### Aspect 19

A hitch adapter 10, according to aspect 18, where the ramp 326 is disposed on a stinger 300.

### Aspect 20

A hitch adapter 10, according to aspect 18, where the ramp 326 is disposed on a brace 322, and the brace 322 is disposed on a stinger 300.

### Aspect 21

A hitch adapter 10, according to aspect 18, where the receiver 204 includes a wedge configured to engage the ramp 326.

### Aspect 22

A hitch adapter 10, including a receiver 204 disposed at an incline 424 relative to a stinger 300 in the closed configuration.

### Aspect 23

A hitch adapter 10, including a locking pin 520 disposed proximate to a rotation joint 500, wherein the locking pin 520 is configured to restrict rotation of the second arm 200 in the open configuration.

### Aspect 24

A hitch adapter 10, including a swing lock 540 disposed along a rotation axis 502.

### Aspect 25

A hitch adapter 10, according to aspect 24, where the swing lock 540 is configured to automatically lock second arm 200 in a at least one position in the open configuration.

### Aspect 26

A hitch adapter 10, according to aspect 24, where the swing lock 540 includes a first stay 542, a second stay 544, and a third stay 546, where first stay 542, second stay 544, and third stay 546 are configured to resist rotation of second arm 200 in a plurality of positions.

### Aspect 27

A hitch adapter 10, according to aspect 26, where the first stay 542, second stay 544, and third stay 546 are configured to receive a tab 548 to resist rotation of second arm 200 at the plurality of positions.

### Aspect 28

A hitch adapter 10, including a rotation joint 500, the rotation joint 500 including a bracket 560.

### Aspect 29

A hitch adapter 10, according to aspect 28, where the bracket 560 is a U-shaped bracket.

### Aspect 30

A hitch adapter 10, according to aspect 28, where a floor 562 of bracket 560 is disposed below at least a portion of the first arm 100 and a ceiling 564 of bracket 560 is disposed above at a least a portion of the first arm 100, to provide access for welding the first arm 100 and the rotation joint 500.

### Aspect 31

A hitch adapter 10, including a rotation joint 500, the rotation joint 500 including bracket 560, a barrel 566, a first protrusion 568 disposed on a lower surface (e.g., floor 562) of the bracket 560, and a second protrusion 570 disposed on the barrel 566.

### Aspect 32

A hitch adapter 10, according to aspect 31, where the first protrusion 568 is configured to rotate about a rotation axis 502 and is configured to abut the second protrusion 570 when the second arm 200 is disposed at an open angle 530 relative to the first arm 100 Aspect 33

A hitch adapter 10 including a first arm 100 extending parallel relative to a first plane (40, 50) in a closed configuration and a second arm 200 pivotably coupled to the first arm 100. The hitch adapter 10 includes a receiver 204 disposed at an end of the second arm 200 and a stinger 300 coupled to and extending orthogonally from the first arm 100 and extending orthogonally relative to the first plane (40, 50), and configured to couple to a vehicle hitch receiver. A proximal end 304 of the stinger 300 is configured to engage the vehicle hitch receiver. The hitch adapter 10 includes a first arm locking pin aperture 522a and a second arm locking pin aperture 522. The first arm locking pin aperture 522a is disposed in a first arm boss 160 and the second arm locking pin aperture 522b is disposed in a second arm boss 260.

### Aspect 34

A hitch adapter 10, according to aspect 33, where the first arm boss 160 extends from the first arm 100 in a direction that is generally orthogonal to the first arm 100 and the second arm boss 260 extends from the second arm 200 in a direction that is generally orthogonal to the second arm 200.

### Aspect 35

A hitch adapter 10, according to aspect 33, where a lock pin 520 extends through the first arm boss 160 and the second arm boss 260 to secure the second arm 200 when the hitch adapter 10 is disposed in the closed configuration.

### Aspect 36

A hitch adapter 10, according to aspect 33, including a first locking arrangement (e.g., 210, 400) and a second locking arrangement (e.g., 160, 260, 520).

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1. A hitch adapter, comprising:
a first arm extending parallel relative to a first plane in a closed configuration;
a second arm pivotably coupled to the first arm;
a receiver disposed at an end of the second arm; and
a stinger coupled to and extending orthogonally from the first arm, extending orthogonally relative to the first plane, and configured to couple to a vehicle hitch receiver,
wherein a proximal end of the stinger is configured to engage the vehicle hitch receiver,
wherein, in the closed configuration, the first arm and the second arm form an acute angle in the first plane, and
wherein a length of the first arm is approximately the same as a length of the second arm.

2. The hitch adapter of claim 1, wherein the first arm comprises a first segment and a second segment, and wherein the first segment is parallel to the second arm in the first plane, and the second segment forms the acute angle with the second arm in the first plane.

3. The hitch adapter of claim 2, wherein the first arm further comprises a third segment disposed parallel to the first segment.

4. The hitch adapter of claim 3, wherein the first segment forms a first end of the first arm and the third segment forms a second end of the first arm.

5. The hitch adapter of claim 3, wherein the third segment is disposed below the first segment.

6. The hitch adapter of claim 2, wherein the first segment comprises a first length and the second segment comprises a second length, and wherein the second length is greater than the first length.

7. The hitch adapter of claim 1, wherein, in the closed configuration, a longitudinal axis of the receiver is collinear with a longitudinal axis of the stinger.

8. The hitch adapter of claim 1, further comprising a brace disposed on an upper surface of the stinger and disposed proximate a distal end of the stinger, and wherein the receiver is configured to abut the brace in the closed configuration.

9. The hitch adapter of claim 1, further comprising a housing disposed at an end of the first arm, wherein the housing is configured to receive a portion of the receiver in the closed configuration.

10. The hitch adapter of claim 9, further comprising an actuator configured to unlock the receiver from the housing, and configured to lock the receiver inside the housing.

11. The hitch adapter of claim 10, wherein the actuator is configured to expand a linkage, and wherein at least a portion of the linkage is configured to contact a floor of the receiver in the closed configuration.

12. A hitch mounted load carrier system, comprising:
a load carrier; and
a hitch adapter comprising:
a first arm,
a second arm pivotably coupled to the first arm at a rotation joint, and configured to pivot from between a closed configuration and an open configuration,
a receiver disposed on the second arm and comprising a first portion and a second portion,
a stinger coupled to and extending orthogonally from the first arm, and
a brace disposed on the stinger,
wherein the brace is configured to apply a normal force to the second portion of the receiver in the closed configuration.

13. The hitch mounted load carrier system of claim 12, further comprising a catch protruding from the brace, and an aperture disposed in the receiver, wherein the aperture is configured to receive the catch in the closed configuration.

14. The hitch mounted load carrier system of claim 13, wherein the catch is configured to restrict vertical movement of the second arm in the closed configuration.

15. The hitch mounted load carrier system of claim 12, wherein the brace comprises a ramp configured to bias the receiver into vertical alignment with a housing.

16. The hitch mounted load carrier system of claim 12, wherein the receiver is disposed at an incline relative to the stinger in the closed configuration.

17. The hitch mounted load carrier system of claim 12, further comprising a housing disposed on the first arm, and a key configured to lock the second arm with the housing in the closed configuration.

18. The hitch mounted load carrier system of claim 17, wherein the receiver comprises a latch disposed on the first portion of the receiver and configured to receive the key in the closed configuration.

19. The hitch mounted load carrier system of claim 18, wherein the key comprises a first portion and a second portion, the latch comprises a first slot configured to receive the first portion of the key, and the latch comprises a second slot configured to receive the second portion of the key.

20. The hitch mounted load carrier system of claim 12, further comprising a locking pin disposed proximate to the rotation joint, wherein the locking pin is configured to restrict rotation of the second arm in the open configuration.
